(19) United States
(12) Patent Application Publication
(10) Pub. No.: US 2021/0164797 A1
(43) Pub. Date: Jun. 3, 2021

(54) METHOD AND APPARATUS FOR DETECTING A POSITION CHANGE OF A LANE MARKER, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Peng SUN, Beijing (CN); Changjie MA, Beijing (CN); Fangwei WANG, Beijing (CN); Yongle ZHANG, Beijing (CN)

(21) Appl. No.: 17/077,419

(22) Filed: Oct. 22, 2020

(30) Foreign Application Priority Data
Dec. 3, 2019 (CN) 201911222372.8

(51) Int. Cl. G01C 21/36; G06K 9/00

(52) U.S. Cl. CPC G01C 21/3602; G06K 9/00798; G06K 9/00744

(57) ABSTRACT

A method, for detecting a position change of a lane marker, includes: determining, based on a first measurement data of a distance between the lane marker and a reference marker on a road that is obtained from a first road data collected via a high-precision device at a first time point, a first set of changed regions between the lane marker and the reference marker in which the distance has changed; determining a second set of changed regions between the lane marker and the reference marker in which the distance has changed based on a second measurement data of the distance that is obtained from a second road data collected via a low-precision device at a second time point after the first time point; and detecting the position change of the lane marker between the first time point and the second time point.

### CROSS REFERENCE TO RELATED APPLICATION

This application claims priority under 35 U.S.C. § 119(a) on Chinese Patent Application No. 201911222372.8, filed with the State Intellectual Property Office of P. R. China on Dec. 3, 2019, the entire contents of which are incorporated herein by reference.

### TECHNICAL FIELD

The present disclosure generally relates to fields of computer technologies and data/image processing technologies, and more particularly, to fields of autonomous driving and electronic maps.

### BACKGROUND

A high-precision map is a machine-oriented digital map applicable for, for example, autonomous driving, robot navigation, and positioning. High-precision maps play an important role in autonomous driving systems. In the entire automatic driving system, environment perception, path planning and positioning system rely on high-precision maps to operate to varying degrees.

The high-precision map is in a high-precision map format, which not only has high accuracy, but also includes other information used for precise navigation and positioning, such as various information about roads. Such information may include, but is not limited to, relevant data information of road marking lines such as lane markers and roadside markers. When the position of the lane marker on the road changes, for example, when the lane marker is redrawn, the lane marker data on the high-precision map also needs to be updated to accurately represent the latest lane marker on the actual road.

### SUMMARY

The present disclosure provides a method for detecting a position change of a lane marker.

In a first aspect, embodiments of the present disclosure provide a method for detecting a position change of a lane marker. The method includes: determining, based on a first measurement data of a distance between the lane marker and a reference marker on a road, a first set of changed regions between the lane marker and the reference marker in which the distance has changed, wherein the first measurement data is obtained from a first road data which is obtained by collecting data of the road via a high-precision device at a first time point; determining a second set of changed regions between the lane marker and the reference marker in which the distance has changed based on a second measurement data of the distance, wherein the second measurement data is obtained from a second road data which is obtained by collecting data of the road via a low-precision device at a second time point after the first time point; and detecting the position change of the lane marker between the first time point and the second time point by comparing the first set of changed regions and the second set of changed regions.

In a second aspect, embodiments of the present disclosure provide an apparatus for detecting a position change of a lane marker, the apparatus includes: a first-set-of-changed-regions determining module, a second-set-of-changed-regions determining module, and a detection module.

The first-set-of-changed-regions determining module is configured to determine, based on a first measurement data of a distance between the lane marker and a reference marker on a road, a first set of changed regions between the lane marker and the reference marker in which the distance has changed, wherein the first measurement data is obtained from a first road data which is obtained by collecting data of the road via a high-precision device at a first time point.

The second-set-of-changed-regions determining module is configured to determine a second set of changed regions between the lane marker and the reference marker in which the distance has changed based on a second measurement data of the distance, wherein the second measurement data is obtained from a second road data which is obtained by collecting data of the road via a low-precision device at a second time point after the first time point.

The detection module is configured to detect the position change of the lane marker between the first time point and the second time point by comparing the first set of changed regions and the second set of changed regions.

In a third aspect, embodiments of the present disclosure provide an electronic device. The electronic device includes: one or more processors; and a memory, configured to store one or more programs, in which when the one or more programs are executed by the one or more processors, the one or more processors are caused to implement the method according to embodiments of the first aspect.

In a fourth aspect, embodiments of the present disclosure provide a computer-readable storage medium on which a computer program is stored, in which when the computer program is executed by a processor, the method according to embodiments of the first aspect is implemented.

It should be understood that the content described in the Summary of present disclosure is not intended to limit key or important features of the embodiments of the present disclosure, nor is it intended to limit the scope of the present disclosure. Additional features of the present disclosure will become easier to understand through the following description.

### BRIEF DESCRIPTION OF THE DRAWINGS

By the following detailed description with reference to the accompanying drawings, the above and additional objects, features, and advantages of the embodiments of the present disclosure will become easier to understand. In the drawings, the embodiments of the present disclosure are shown in an exemplary and non-limiting manner.

FIG. 1 is a schematic diagram of an example environment in which some embodiments of the present disclosure can be implemented.

FIG. 2 is a flowchart of an example process of detecting a position change of a lane marker according to an embodiment of the present disclosure.

FIG. 3A is a schematic diagram of determining a first set of changed regions based on first measurement data of a distance between a lane marker and a reference marker according to an embodiment of the present disclosure.

FIG. 3B is a schematic diagram of determining a second set of changed regions based on second measurement data of a distance between a lane marker and a reference marker according to an embodiment of the present disclosure.

FIG. 4 is a schematic diagram of geometric principle of detecting a position change of a lane marker according to an embodiment of the present disclosure, which illustrates that within a significant changed region, the amount of change in the distance between the lane marker and the reference marker reaches a threshold, and a length of the significant changed region reaches a predetermined length.

FIG. 5 is a flowchart of an example process of obtaining first measurement data from first road data according to an embodiment of the present disclosure.

FIG. 6 is a schematic diagram of determining first measurement data by sampling lane marker data from first road data according to an embodiment of the present disclosure.

FIG. 7 is a flowchart of an example process of obtaining second measurement data from second road data according to an embodiment of the present disclosure.

FIG. 8 is a schematic diagram of determining second measurement data by sampling lane marker data from second road data according to an embodiment of the present disclosure.

FIG. 9 is a flowchart of an example process of obtaining second lane marker data and second reference marker data from second road data according to an embodiment of the present disclosure.

FIG. 10 is a flowchart of an example process of determining lane marker sampled points and reference marker sampled points from a video frame that presents lane marker and reference markers according to an embodiment of the present disclosure.

FIG. 11 is a schematic diagram of determining a lane marker sampled point and a reference marker sampled point in a video frame according to an embodiment of the present disclosure.

FIG. 12 is a flowchart of an example process of determining a changed region from first road data according to an embodiment of the present disclosure.

FIG. 13 is a flowchart of an example process of determining a changed point based on first measurement data according to an embodiment of the present disclosure.

FIG. 14 is a schematic diagram of determining a changed point based on first measurement data according to an embodiment of the present disclosure.

FIG. 15 is a flowchart of an example process of determining a changed region from second road data according to an embodiment of the present disclosure.

FIG. 16 is a flowchart of an example process of determining a changed point based on second measurement data according to an embodiment of the present disclosure.

FIG. 17 is a schematic diagram of determining a changed point based on second measurement data according to an embodiment of the present disclosure.

FIG. 18 is a flowchart of an example process of correcting second measurement data by using first measurement data according to an embodiment of the present disclosure.

FIG. 19 is a flowchart of an example process of determining a first measured distance from first road data according to an embodiment of the present disclosure.

FIG. 20 is a schematic diagram of determining a first measured distance from first road data according to an embodiment of the present disclosure.

FIG. 21 is a flowchart of an example process of determining a second measured distance from second road data according to an embodiment of the present disclosure.

FIG. 22 is a schematic diagram of determining the second measured distance from second road data according to an embodiment of the present disclosure.

FIG. 23 is a schematic diagram of processing the first measurement data and the second measurement data using backward stabilization window and forward smoothing window according to an embodiment of the present disclosure.

FIG. 24 is a schematic diagram of an apparatus for detecting a position change of a lane marker according to an embodiment of the present disclosure.

FIG. 25 is a schematic diagram of a device for implementing an embodiment of the present disclosure.

In the drawings, the same or similar reference numerals are used to indicate the same or similar components.

### DETAILED DESCRIPTION

The principle and spirit of the present disclosure will be described below with reference to exemplary embodiments shown in the drawings. It is understood that these specific embodiments are described only to enable those skilled in the art to better understand and implement the present disclosure, and do not limit the scope of the present disclosure in any way.

### Analysis and Research of Conventional Solutions

The production and updating of high-precision maps is an important business for map providers. The production of high-precision maps generally refers to data collection on roads through map collecting vehicles equipped with surveying-level high-precision sensors, and high-precision collecting vehicles are expensive and limited in number. The updating of high-precision maps refers to the discovery of changes through effective technical means when road elements change. Changes in road elements include, but are not limited to, additions and deletions of traffic facilities poles, signs, and changes in spatial position and attributes, and changes in attributes such as the spatial position and color line type of lane markers.

High-precision maps are updated in a conventional manner through high-precision collecting vehicles. However, this update method has a long period (generally more than one month or even months), and cannot be performed on a daily or real-time basis. Since high-precision collecting vehicles are expensive and few in number, and it is impossible to achieve high-frequency road data collection due to high cost and feasibility.

High-precision maps are updated in another conventional manner by using a drive recorder to discover changes in road elements based on visual simultaneous positioning and mapping (SLAM). In detail, since the drive recorder is mainly equipped with a monocular camera, the conventional method is mainly a visual monocular SLAM method, commonly, dense real-time tracking and mapping (DTAM) algorithm, large-scale direct monocular (LSD)-SLAM algorithm, ORB-SLAM algorithm, and ROVIO-SLAM algorithm.

Inventors found through research and analysis that the above two conventional manners of detecting a position change of a lane marker have deficiencies. For the first conventional manner, data obtained by using high-precision collecting vehicles for re-collecting is reliable and has high accuracy. However, it's obvious that this manner cannot be popularized to detect a position change of a lane marker in a short period nationwide and update high-precision map, as detailed below.

Firstly, high-precision collecting vehicles are expensive, limited in number, and high in collection cost, thus it is impossible to maintain a large high-precision collecting fleet to cover national road networks. Secondly, the operation period of high-precision collecting vehicle is long, and it may take days to collect data for square kilometers. In order to ensure operation quality, there are redundant operation processes and requirements in field processing and the indoor processing. The whole operation process of collecting field vehicles, processing of original indoor data, extracting automated road elements, and manual operations and quality inspections is complex and enormous. Therefore, it is difficult to rapidly detect a position change of a lane marker in a single operation.

For the second conventional manner, the visual SLAM is limited by the following three types of errors: errors caused by lack of large-scale calibration by consumer-level drive recorders, errors caused by registration of SLAM maps and high-precision map elements, and cumulative errors generated due to long distance of the SLAM itself.

### Overall Thoughts and Basic Principles

Detecting a position change of a lane marker is part of update of the high-precision map, that is, the position change of a lane marker is found firstly, and then the lane marker is updated at the change position by a high-precision collecting vehicle or other technical means.

The inventors have noticed that a large number of low-cost consumer-level drive recorders have been popularized. If these mass devices are used to obtain position change of the lane marker (e.g., when the lane marker is redrawn), change discovery and update of high-precision maps is timely and effective, thereby greatly improving safety of autonomous driving systems and achieving great practical value.

After observation and experiments, the inventors found that lane width recognized by the camera of the consumer-level drive recorder is reliable, stable, and can be normalized to the true lane width, and its perceptual error is generally less than 0.2 meters. If a roadside marker to the leftmost lane is also regarded as an imaginary lane, when the lane marker is redrawn (generally causing a position change greater than 0.2 meters), width change of the above imaginary lane is unavoidable, and is perceived by the camera of the consumer-level drive recorder. Therefore, it is feasible to detect the position change of the lane marker based on the change of the lane width through crowd-sourced consumer-level drive recorders.

In view of the above research and analysis, the embodiments of the present disclosure provide a technical solution for detecting a position change of a lane marker to at least partially solve the foregoing technical problems and other potential technical problems existing in the conventional solutions. In the technical solution of the present disclosure, on one hand, the first measurement data of the distance between the lane marker and the reference marker (e.g., the roadside marker) is obtained from the first road data which is obtained by collecting data of the road via a high-precision device at a first time point (for example, the device for collecting high-precision map data). Then, based on the first measurement data, a first set of changed regions between the lane marker and the reference marker in which the distance has changed is determined.

On the other hand, the second measurement data of the above distance is obtained from the second road data which is obtained by collecting data of the road via a low-precision device (for example, a drive recorder) at a second time point after the first time point. Then, based on the second measurement data, a second set of changed regions between the lane marker and the reference marker in which the distance has changed. Then, the position change of the lane marker between the first time point and the second time point is detected by comparing the first set of changed regions and the second set of changed regions.

The technical solution of the present disclosure effectively solves the problem of detecting the position change of the lane marker for updating the high-precision map, and effectively detects the position change of the lane marker at a low cost. In detail, the technical solution of the present disclosure is based on low-precision devices (also known as crowd-sourced devices) to discover the position change of the lane marker, so it is possible to obtain the spatial position of the lane marker redraw nationally, thereby making it possible to update the high precision maps, especially the position of lane markers in HD maps. In addition, the embodiments of the present disclosure also have the following technical advantages.

Firstly, the technical solution of the present disclosure detects the position change of the lane marker by using common low-cost low-precision devices (for example, consumer-level drive recorders). Most existing drive recorders meet the technical requirements of this technical solution. For example, these requirements may include a satellite positioning system (for example, GPS) module with a horizontal accuracy of 2 meters to 5 meters, a course accuracy of less than or equal to 0.3 degrees, and a shooting camera (camera) without internal parameters to perform distortion correction.

Secondly, the technical solution of the present disclosure is not limited by geographic space and algorithm, and realizes detection of the position change of the lane marker nationally. The core idea of this technical solution, i.e., “detecting position change through the width of the lane” only depends on the data collected by high-precision devices at the current position (for example, high-precision maps) unlike conventional SLAM method that require calculation of front and back frames, thus cumulative errors are avoidable.

Thirdly, the technical solution of the present disclosure has no requirement on the number of collections of road data. In this technical solution, data of the same road area can be collected for 2 to 3 times, or just one time. It is noted that this technical solution does not recommend that the number of acquisitions be greater than 3, so the number of acquisitions mainly serves to increase confidence of the changed region. The reduction in the number of road data collections reduces the cost of data collection, which has great advantages for nationwide popularization. Some example embodiments of the present disclosure are described below with reference to the drawings.

### Example Environment

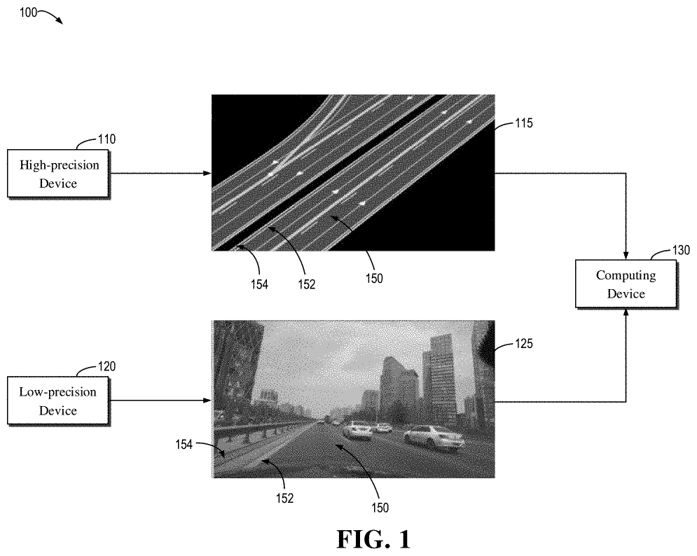

FIG. 1 is a schematic diagram of an example environment 100 in which some embodiments of the present disclosure can be implemented. As illustrated in FIG. 1, the example environment 100 may include a high-precision device 110, a low-precision device 120, and a computing device 130.

On one hand, the high-precision device 110 collects road information and data on a road 150 at a first time point T1, and obtains a first road data 115 of the road 150. The first road data 115 includes relevant data and information of a lane marker 152 and a reference marker 154 (e.g., a roadside marker), which may indicate a position of the lane marker 152 and a position of the reference marker 154 at the first time point T1. In addition, the high-precision device 110 provides the first road data 115 to the computing device 130 for processing.

In some embodiments, the high-precision device 110 may be a high-precision map collecting vehicle equipped with mapping-level high-precision sensors, which collect data of the road 150 during a long collection period (for example, one month). In this case, the first road data 115 may be a high-precision map obtained after processing the road data collected by the high-precision device 110. In addition to the high-precision map collecting vehicle, the high-precision device 110 may also include any other device for collecting high-precision map data. Generally, the high-precision device 110 may include any device capable of determining position of a lane marker or other road element with higher accuracy (e.g., an error is below a threshold, such as 20 cm).

On the other hand, the low-precision device 120 performs road information and data collection on the road 150 at a second time point T2 after the first time point T1 to obtain a second road data 125 of the road 150. The second road data 125 also includes relevant data and information of the lane marker 152 and the reference marker 154, which may indicate the position of the lane marker 152 and the position of the reference marker 154 at the second time point T2. In addition, the low-precision device 120 provides the second road data 125 to a computing device 130 for processing.

In some embodiments, the low-precision device 120 may be a drive recorder (also referred to herein as a crowdsourcing device) installed on an ordinary vehicle, which may collect data of the road 150 more frequently and at a lower cost. In this case, the second road data 125 may be videos or images taken on the road 150 and/or satellite positioning data when shooting is performed. Generally, the low-precision device 120 may include any device capable of determining the position of the lane marker or other road elements with low accuracy (e.g., an error is higher than a threshold, such as 20 cm).

The computing device 130 obtains the first road data 115 from the high-precision device 110, and obtains the second road data 125 from the low-precision device 120. As described above, position change of the lane marker 152 changes the distance between the lane marker 152 and the reference marker 154, so the computing device 130 may determine the first set of changed regions where the distance between the lane marker 152 and the reference marker 154 changes at the first time point T1 from the first road data 115. The changed region here refers to the area between the lane marker 152 and the reference marker 154. Similarly, the computing device 130 may determine a second set of changed regions where the distance between the lane marker 152 and the reference marker 154 changes at the second time point T2 from the second road data 125. Then, by comparing the first set of changed regions and the second set of changed regions, the computing device 130 can determine the position change of the lane marker 152 between the first time point T1 and the second time point T2.

In some embodiments, the computing device 130 may include any device capable of implementing computing functions and/or control functions, which may be any type of fixed computing device, mobile computing device, or portable computing device, including but not limited to, dedicated computers, general computers, desktop computers, laptop computers, notebook computers, netbook computers, tablet computers, multimedia computers, mobile phones, general processors, microprocessors, microcontrollers, or state machines. The computing device 130 may also be implemented as an individual computing device or a combination of computing devices, for example, a combination of digital signal processors (DSP) and microprocessors, multiple microprocessors, one or more microprocessors combined with a DSP core, or any other configurations. In addition, in the context of this disclosure, the computing device 130 may also be referred to as an electronic device 130, and these two terms may be used interchangeably herein.

As described herein, “lane marker” refers to a solid or dashed line on a road used to separate different lanes. The reference marker refers to a marking line, an auxiliary line, a roadside marker on a road extending substantially parallel to the lane marker. In some embodiments, the reference marker may include a roadside marker, which represent boundaries of a portion of the road for vehicle use, in which “for vehicle use” refers to conditions where vehicles are driven under normal conditions and in emergencies, for example, when parking in emergencies or avoiding other vehicles. For example, the roadside marker may be the boundary of a curb stone located at the center of the road, or the boundary of other objects (e.g., road curbs) protruding from the ground.

Design Specification for Highway Route does not give the definition of “roadside marker” on both sides of the road, but in Section 4.2.5.1: “lane marker” of “Intelligent Driving Electronic Map Data Model of Intelligent Transportation System and Exchange Format Section 1: Highway (Exposure Draft)”, a production principle of “roadside marker” may be provided. Referring to a curb, the production principles stipulate that “when there is no lane marker on the outermost side of the road, a roadside marker need to be drawn along the intersection of the curb and the ground as the outer lane marker of the road”. For the geometric shape of curbs, please refer to the section of G.2 “cross sectional graph” of “JCT 899-2016 Concrete Curbstones”. In practice, data of the roadside marker is generally provided in a high-precision map, and the production principle of the roadside marker is “drawn along the intersection of the curb and the ground”.

As mentioned above, for simplicity of description, this article sometimes also consider the area between the lane marker and the roadside as a “lane”, so the distance between the lane marker and the roadside marker can also be called “width of the lane”. In addition, in this article, the lane marker discussed generally refers to the lane marker on the road closest to the roadside marker, for example, the innermost or outermost lane marker of the road. However, it is understood that the embodiments of the present disclosure are not limited to this, but are equally applicable for other lane markers farther away from the roadside marker.

In other embodiments, in addition to the roadside markers, the reference markers may also include other lane markers different from the lane marker discussed. For example, additional lane markers may be the other lane marker that forms one lane with the lane marker discussed. In this case, the distance between the lane marker discussed and the other lane marker is the width of the lane. The other lane marker may also be another lane marker that belongs to a different lane from the lane marker discussed. In this case, the distance between the lane marker discussed and the other lane marker may be the width of a plurality of lanes.

In other words, as far as the road elements are concerned, the technical solution proposed by the embodiments of the present disclosure to detect the position change of the lane marker based on the “lane width” include the following types of lane width. The first type of lane width is the width of the lane between “the left side of the road” and “the leftmost lane marker”. The second type of lane width is the lane width of “middle lanes” between “the leftmost lane marker” to “the rightmost lane marker”. The third type of lane width is the width of the lane from “the rightmost lane marker” to “the right side of the road”. In some embodiments, the first and third types of lane width of the above three types may be considered as the main types of changes, since redrawing the lane markers generally refer to redrawing of the outer lane markers. Therefore, the following description of the embodiments take the first type of lane width as an example, but it is understood that the principles of the embodiments of the present disclosure are also applicable for the second type of lane width and the third type of lane width.

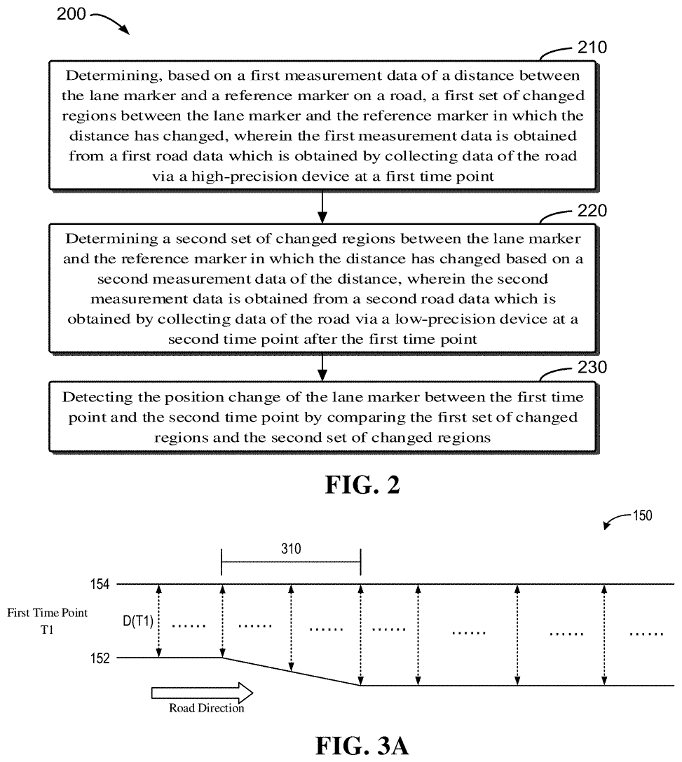

In addition, it is understood that FIG. 1 only schematically illustrates units, elements, modules, or components in the example environment 100 related to the embodiments of the present disclosure. In practice, the example environment 100 may also include other units, elements, modules, or components for other functions. In addition, the specific number of units, elements, modules, or components shown in FIG. 1 is only exemplary and is not intended to limit the scope of the present disclosure in any way. In other embodiments, the example environment 100 may include any suitable number of high-precision devices, low-precision devices, and computing devices. Therefore, the embodiments of the present disclosure are not limited to the specific devices, units, elements, modules, or components depicted in FIG. 1, but are generally applicable for any technical environment that detects a position change of a lane marker. The following describes an example process of an embodiment of the present disclosure with reference to FIGS. 2 to 4.

### Example Process for Detecting a Position Change of a Lane Marker

FIG. 2 is a flowchart of an example process 200 of detecting a position change of a lane marker according to an embodiment of the present disclosure. In some embodiments, the example process 200 may be implemented by the computing device 130 in the example environment 100, for example, may be implemented by a processor or processing unit of the computing device 130, or by various function modules of the computing device 130. In other embodiments, the example process 200 may also be implemented by computing devices independent of the example environment 100, or may be implemented by other units or modules in the example environment 100.

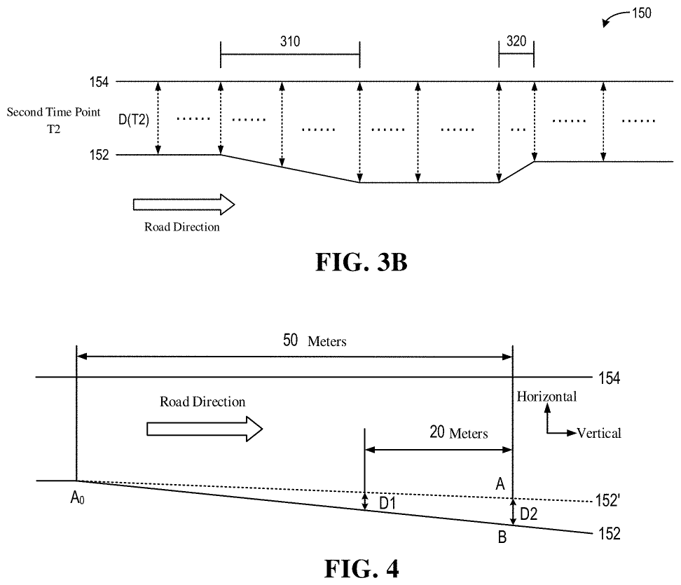

FIG. 3A is a schematic diagram of determining a first set of changed regions based on first measurement data D(T1) of a distance D between a lane marker 152 and a reference marker 154 according to an embodiment of the present disclosure. In addition, FIG. 3B is a schematic diagram of determining a second first set of changed regions based on the second measurement data D (T2) of the distance between the lane marker 152 and the reference marker 154 according to an embodiment of the present disclosure.

In FIG. 3A, the lane marker 152 and the reference marker 154 are schematic representations obtained from the first road data 115 collected on the road 150 by the high-precision device 110 at the first time point T1. Therefore, the distance D(T1) between the lane marker 152 and the reference marker 154 depicted in FIG. 3A is actually measurement data obtained from the first road data 115 for the true distance D between the lane marker 152 and the reference marker 154. In the following, for convenience of discussion, the measurement data of the distance D obtained from the first road data 115 may also be referred to as the first measurement data D (T1). In addition, it is understood that the specific shapes, road directions, and other elements of the lane marker 152 and the reference marker 154 depicted in FIG. 3A are merely schematic, and are not intended to limit the scope of the present disclosure in any way. In other embodiments, the lane marker 152 and the reference marker 154 may have any shape, and the road direction may be different from the illustrated direction.

Similarly, in FIG. 3B, the lane marker 152 and the reference marker 154 are schematic representations respectively obtained from the second road data 125 collected by the low-precision device 120 on the road 150 at the second time point T2 after the first time point T1. Therefore, the distance D (T2) between the lane marker 152 and the reference marker 154 depicted in FIG. 3B is actually the measurement data obtained from the second road data 125 for the true distance D between the lane marker 152 and the reference marker 154. In the following, for convenience of discussion, the measurement data of the distance D obtained from the second road data 125 may also be referred to as the second measurement data D (T2). In addition, it is understood that the specific shapes, road directions, and other elements of the lane marker 152 and the reference marker 154 depicted in FIG. 3B are merely schematic, and are not intended to limit the scope of the present disclosure in any way. In other embodiments, the lane marker 152 and the reference marker 154 may have any shape, and the road direction may be different from the illustrated direction.

As illustrated in FIGS. 2 and 3A, at 210, the computing device 130 determines the first set of changed regions where the distance between the lane marker 152 and the reference marker 154 has changed based on the first measurement data D (T1) of the distance D between the lane marker 152 and the reference marker 154 on the road 150, for example, {310}. It is understood that only one changed region 310 in the first set of changed regions is depicted in FIG. 3A, which is only exemplary and is not intended to limit the scope of the present disclosure in any way. In other embodiments, the first set of changed regions may include any number of changed regions.

As illustrated in FIG. 3A, in the changed region 310, the first measurement data D (T1) is changed. For example, in this example, the change in the first measurement data D (T1) is caused due to the position change of the lane marker 152 relative to the reference marker 154. In detail, the first measurement data D(T1) gradually increases along the road direction in the changed region 310. However, it is understood that this particular variation in the first measurement data D(T1) is only exemplary and is not intended to limit the scope of the present disclosure in any way. In other embodiments, the first measurement data D(T1) may be changed in any other manner in the determined changed region, for example, the data may gradually become smaller, or suddenly larger or smaller, or jumping may occur in the data. In other embodiments, the change of the first measurement data D(T1) may also be caused by measurement errors.

In practice, since there are certain errors when drawing the lane marker and the reference marker (for example, the roadside marker) on the road, a small change in the distance between the lane marker and the reference marker may not be practically meaningful. In other words, significant changes in the distance D between the lane marker 152 and the reference marker 154 is worthy of detection and attention. Therefore, in some embodiments, in each changed region in the first set of changed regions, the variation in the distance D(T1) between the lane marker 152 and the reference marker 154 reaches a threshold, and the length of each changed region reaches a predetermined length. That is, in the embodiments, the changed region that satisfies the above conditions is regarded as the area where the distance D changes significantly. In this way, in the process of identifying the changed region where the distance D changes, the computing device 130 may filter out the changed region where the distance D changes less or the length of the changed region is shorter, thereby improving the efficiency and effectiveness of identifying the changed regions.

It is understood that the variation threshold and the predetermined length here are determined by those skilled in the art according to factors such as actual requirement of measurement accuracy and technical environment. However, since the example process 200 is ultimately to detect the position change of the lane marker 152, it may be advantageous to determine the aforementioned variation threshold and the predetermined length based on significant changes in the position of the lane marker 152 that is worthy of detection and attention. In this way, the efficiency and effectiveness of the computing device 130 in detecting the position change of the lane marker 152 is further improved. Such an example is described below with reference to FIG. 4.

FIG. 4 is a schematic diagram of geometric principle of detecting a position change of a lane marker according to an embodiment of the present disclosure, which illustrates that within a significant changed region, the amount of change in the distance between the lane marker and the reference marker reaches a threshold, and a length of the significant changed region reaches a predetermined length. As illustrated in FIG. 4, a lane marker 152′ is a hypothetical original lane marker (also referred to as an old lane marker), assuming that it coincides with the lane marker 152 at position AO, but extends in a different direction of the lane marker 152 along the road. Based on simple geometric calculations while taking into account the detection capabilities of the low-precision device 120, the following detection conditions for the position change of the lane marker 152 that are feasible in practice can be derived.

If the line width of the actual lane marker is not considered, when lateral deviation (D1) of the position of the lane marker 152 reaches 0.2 meters and the longitudinal length exceeds 20 meters, it is considered that the position change of the lane marker 152 is significant, and the position change of the lane marker 152 is widely found through the low-precision device 120 (for example, a consumer-level drive recorder). In addition, considering that the position change of the lane marker 152 is generally consecutive, the detection condition of the above position change is equivalent to: at a longitudinal position of 50 meters, lateral deviation (D2) reaches about 0.33 meters, and the expression can be expressed as Δ50 (D2)=|AB|50>=0.33 meters. Further, if the width of the lane marker itself is considered (for example, generally 20 cm), and it is assumed that the new and old lane markers are overlapped partially, the overlapped portion is not considered to be redrawn, then the above detection conditions can be relaxed to: 50 meters at the longitudinal position, the lateral deviation exceeds 0.53 meters, and the expression can be expressed as Δ50 (D2)=|AB|50>=0.53 meters.

Therefore, in some embodiments, the above-mentioned variation threshold for determining the “significant” changed region may be set to 0.2 meters, and the predetermined length may be set to 20 meters. That is, if the variation in the first measurement data D(T1) of the distance D between the lane marker 152 and the reference marker 154 in a changed region reaches 0.2 meters, and the length of the changed region along the road direction is greater than 20 meters, then the computing device 130 may consider the changed region to be a region worthy of detection and attention where the distance D changes significantly. It is understood that any specific numerical values listed here are only exemplary and are not intended to limit the scope of the present disclosure in any way. In other embodiments, any of the above-mentioned numerical values may be other suitable values.

As described above, the first measurement data D(T1) is obtained from the first road data 115 collected by the high-precision device 110. In detail, the computing device 130 may obtain the first measurement data D(T1) from the first road data 115 in any suitable manner, which may depend on the specific form of the first road data 115. In some embodiments, the first road data 115 collected by the high-precision device 110 on the road 150 may directly include the first measurement data D(T1) between the lane marker 152 and the reference marker 154. For example, when collecting data on the road 150, the high-precision device 110 directly measures the distance between the lane marker 152 and the reference marker 154. In this case, the computing device 130 directly extracts the first measurement data D(T1) from the first road data 115.

Alternatively, in other embodiments, the first road data 115 collected by the high-precision device 110 on the road 150 may not directly include the first measurement data D(T1) between the lane marker 152 and the reference marker 154. For example, the first road data 115 may be a high-precision map formed after processing the data collected by the high-precision device 110, which may include relevant data and information of the lane marker 152 and the reference marker 154, but may not directly include distance data between the lane marker 152 and the reference marker 154. In this case, the computing device 130 may derive or calculate the first measurement data D(T1) from the first road data 115. Such examples are described further below.

After obtaining the first measurement data D(T1), the computing device 130 may determine the first set of changed regions from the first measurement data D(T1) in any appropriate manner, for example, {310}. For example, in some embodiments, the computing device 130 may represent the first measurement data D(T1) as a function of a coordinate position on the lane marker 152 or the reference marker 154. In such an embodiment, the computing device 130 may mathematically process the function of the first measurement data D(T1), such as solving a first derivative function or a second derivative function of the function. Furthermore, the computing device 130 may analyze a coordinate position range of the lane marker 152 or the reference marker 154 where the first measurement data D(T1) changes, so as to obtain the first set of changed regions. Alternatively, in other embodiments, the computing device 130 may also determine the first set of changed regions based on the way in which the lane marker data of the lane marker 152 is sampled. Such examples are described further below.

As illustrated in FIGS. 2 and 3B, at 220, the computing device 130 determines the second set of changed regions between the lane marker 152 and the reference marker 154 where the distance D has changed based on the second measurement data D(T2) of the distance D between the lane marker 152 and the reference marker 154, for example, {310, 320}. It is understood that only two changed regions 310 and 320 in the second set of changed regions are depicted in FIG. 3B, which are only schematic and not intended to limit the scope of the present disclosure in any way. In other embodiments, the second set of changed regions may include any number of changed regions.

As illustrated in FIG. 3B, in the changed regions 310 and 320, the second measurement data D(T2) is changed. For example, in this embodiment, the change in the second measurement data D(T2) is caused by the position change of the lane marker 152 relative to the reference marker 154. In detail, the second measurement data D(T2) gradually increases along the road direction in the changed region 310, and gradually decreases along the road direction in the changed region 320. However, it is understood that this particular variation in the second measurement data D(T2) is only exemplary and is not intended to limit the scope of the present disclosure in any way. In other embodiments, the second measurement data D(T2) may be changed in any other way in the determined changed region, for example, gradually becoming smaller, or suddenly larger or smaller, or jumping may occur in the data. In other embodiments, the variation in the second measurement data D(T2) may also be caused by measurement errors.

As noted above, in practice, since there are certain errors when drawing the lane marker and the reference marker (for example, the roadside marker) on the road, a small change in the distance between the lane marker and the reference marker may not be practically meaningful. In other words, significant changes in the distance D between the lane marker 152 and the reference marker 154 is worthy of detection and attention. Therefore, in some embodiments, similar to the way the first set of changed regions is handled, in each changed region in the second set of changed regions, the variation in the distance D(T2) between the lane marker 152 and the reference marker 154 reaches a threshold, and the length of each changed region reaches a predetermined length. That is, in the embodiments, the changed region that satisfies the above conditions is regarded as the area where the distance D changes significantly. In this way, in the process of identifying the changed region where the distance D changes, the computing device 130 may filter out the changed region where the distance D changes less or the length of the changed region is shorter, thereby improving the efficiency and effectiveness of identifying the changed regions.

Similarly, the variation threshold and the predetermined length here can be determined by the those skilled in the art according to the actual requirements of measurement accuracy and technical environment and other factors, and can be used to determine whether the variation amount threshold and the predetermined length of the samples of the first set of changed regions are identical. As noted above, since the example process 200 is ultimately to detect the position change of the lane marker 152, it may be advantageous to determine the above variation threshold and the predetermined length based on the significant position change of the lane marker 152 that is worthy of detecting and attention. In this way, the efficiency and effectiveness of the computing device 130 in detecting the position change of the lane marker 152 is further improved.

Therefore, based on the analysis with reference to FIG. 4, in some embodiments, the above-mentioned variation threshold for determining the “significant” changed region may be set to 0.2 meters, and the predetermined length may be set to 20 meters. That is, if variation in the second measurement data D(T2) of the distance D between the lane marker 152 and the reference marker 154 within a changed region is up to 0.2 meters, and the length of the changed region along the road direction is greater than 20 meters, then, the computing device 130 may consider the changed region to be a region worthy of detection and attention where the distance D changes significantly. It is understood that any specific numerical values listed here are only exemplary and are not intended to limit the scope of the present disclosure in any way. In other embodiments, any of the above-mentioned numerical values may be other proper values.

As described above, the second measurement data D(T2) is obtained from the second road data 125 collected by the low-precision device 120. In detail, the computing device 130 may obtain the second measurement data D(T2) from the second road data 125 in any suitable manner, which may depend on the specific form of the second road data 125. In some embodiments, the second road data 125 collected by the low-precision device 120 on the road 150 may directly include the second measurement data D(T2) between the lane marker 152 and the reference marker 154. For example, when collecting data of the road 150, the low-precision device 120 may directly measure the distance between the lane marker 152 and the reference marker 154. In this case, the computing device 130 may directly extract the second measurement data D(T2) from the second road data 125.

Alternatively, in other embodiments, the second road data 125 collected by the low-precision device 120 on the road 150 may not directly include the second measurement data D(T2) between the lane marker 152 and the reference marker 154. For example, the second road data 125 may be a video or image of the lane marker 152 and the reference marker 154 taken by the low-precision device 120, which may include relevant data and information of the lane marker 152 and the reference marker 154, but may not directly include distance data between the lane marker 152 and the reference marker 154. In this case, the computing device 130 may derive or calculate the second measurement data D(T2) from the second road data 125. Such examples are described further below.

After obtaining the second measurement data D(T2), the computing device 130 may determine the second set of changed regions based on the second measurement data D(T2) in any proper manner, for example, {310, 320}. For example, in some embodiments, the computing device 130 may represent the second measurement data D(T2) as a function of the coordinate position on the lane marker 152 or the reference marker 154. In such an embodiment, the computing device 130 may mathematically process the function of the second measurement data D(T2), such as solving the first derivative function or the second derivative function of the function. Furthermore, the computing device 130 may analyze the coordinate position range of the lane marker 152 or the reference marker 154 corresponding where the second measurement data D (T2) changes, thereby obtaining the second changed region set. In other embodiments, the computing device 130 may also determine the second set of changed regions based on the manner in which the lane marker data of the lane marker 152 is sampled. Such examples are described further below.

As illustrated in FIGS. 2, 3A, and 3B, at 230, the computing device 130 detects the position change of the lane marker 152 between the first time point T1 and the second time point T2 by comparing the first set of changed regions (eg, {310}) and the second set of changed regions (eg, {310, 320}). In detail, since the first set of changed regions is determined based on the first road data 115 collected by the high-precision device 110, it is considered that the first set of changed regions already includes the changed region where the distance D between the lane marker 152 and the reference marker 154 changes at the first time point T1.

On the other hand, since the “lane width” measured by the low-precision device 120 (i.e., the distance D between the lane marker 152 and the reference marker 154) is reliable (e.g., errors are within an acceptable range). Therefore, the second set of changed regions determined from the second road data 125 may be considered to include the changed region where the distance D between the lane marker 152 and the reference marker 154 changes at the first time point T2. Therefore, if the second set of changed regions includes more new changed regions than the first set of changed regions, it is considered that the distance D between the lane marker 152 and the reference marker 154 changes between the first time point T1 and the second time point T2 in the new changed region. Further, generally, the reference marker 154 (e.g., the roadside marker) is assumed to remain at the same position, so the computing device 130 may determine that the position of the lane marker 152 has changed in the above-mentioned new changed region. Conversely, if the changed region included in the second set of changed regions is the same as the changed region in the first set of changed regions, the computing device 130 may determine that there is no position change of the lane marker 152 between the first time point T1 and the second time point T2.

Therefore, in some embodiments, in order to detect the position change of the lane marker 152, the computing device 130 may determine a changed region in the second set of changed regions that is different from the changed regions in the first set of changed regions, for example, the changed region 320. Then, the computing device 130 may determine that the position of the lane marker 152 in the changed region 320 has changed. In this way, in the process of determining the position change of the lane marker 152, the computing device 130 may filter out the original changed region where the distance D has already changed at the first time point T1, thereby improving the efficiency and accuracy of detecting the position change of the lane marker 152.

Additionally or alternatively, in the case where the reference marker 154 is a roadside marker, the opening in the central reservation of the road 150 affects the roadside marker. For example, there may not be real roadside marker at the opening in the central reservation, and in practice, disconsecutive roadside marker may be supplemented by fitting or simulation. However, such a supplementary roadside marker may cause a large measurement error of the distance D between the lane marker 152 and the reference marker 154. Therefore, in order to improve the accuracy of detecting the position change of the lane marker 152, the computing device 130 may also need to remove misidentifications caused by the opening in the central reservation, for example, the perception module for road elements is used to determine whether a certain changed region corresponds to the opening in the central reservation.

In detail, in the case where the reference marker 154 is a roadside marker, the computing device 130 may determine whether the above-mentioned different changed region 320 corresponds to the opening in the central reservation of the road 150 based on the first road data 115. Next, if the computing device 130 determines that the changed region 320 does not correspond to the opening in the central reservation, it may be determined that the lane marker 152 has changed position in the changed region 320. In this way, in the process of determining the position change of the lane marker 152, the computing device 130 can eliminate interferences caused by the measurement errors at the opening in the central reservation, thereby improving the accuracy of identifying the position change of the lane marker. Additionally or alternatively, the computing device 130 may also determine whether the changed region 320 corresponds to the opening in the central reservation based on the second road data 125.

In addition, in some embodiments, the computing device 130 may use a plurality of road data collected on the road 150 for several times by the low-precision device 120 to verify the above-mentioned changed region 320. For example, in the case where the low-precision device 120 is a drive recorder, the vehicle on which the low-precision device 120 is installed may have to cross the road 150 for several times within a predetermined period (for example, one day). Therefore, the low-precision device 120 can perform data collections on the road 150 repeatedly. If the new changed region 320 is detected in the data collected for several times, it is considered that the detected changed region 320 is credible. Alternatively, if the new changed region 320 is detected in more than a predetermined proportion (for example, 60%) of the collected data, the computing device 130 may consider the changed region 320 to be a valid changed region. In this way, the accuracy of identifying the position change of the lane markert by the computing device 130 is improved. It is understood that the specific numerical values given here are only exemplary and are not intended to limit the scope of the present disclosure in any way. In other embodiments, the above-mentioned predetermined ratio may also be set to any proper value.

Alternatively or additionally, the computing device 130 may use additional road data collected on the road 150 by another low-precision device different from the low-precision device 120 to verify the above-mentioned different changed region 320. For example, in the case where the low-precision device is a drive recorder, the computing device 130 may detect whether the changed region 320 exists from the data collected by a plurality of drive recorders on the road 150. In this way, the accuracy of identifying the position change of the lane markert by the computing device 130 is improved.

### Example Process for Determining the First Measurement Data and the Second Measurement Data

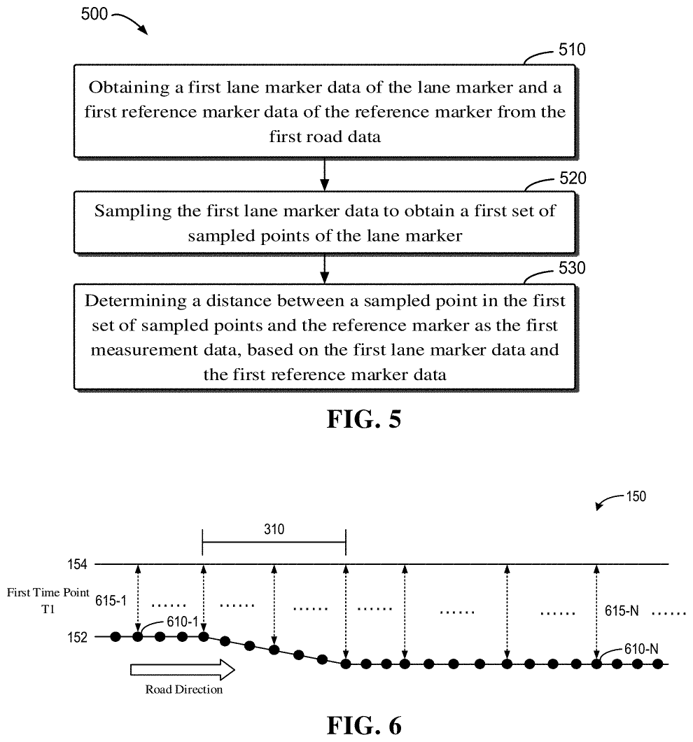

As mentioned above when describing the block 210 of the example process 200, the first road data 115 collected by the high-precision device 110 on the road 150 may not directly include the first measurement data D(T1) between the lane marker 152 and the reference marker 154. For example, the first road data 115 may be a high-precision map formed after processing the data collected by the high-precision device 110, which may include the relevant data and information of the lane marker 152 and the reference marker 154, but may not directly include the distance data between the lane marker 152 and the reference marker 154. In this case, the computing device 130 may derive or calculate the first measurement data D(T1) from the first road data 115. Such examples are described below with reference to FIGS. 5 and 6.

FIG. 5 is a flowchart of an example process 500 of obtaining first measurement data D(T1) from first road data 115 according to an embodiment of the present disclosure. In some embodiments, the example process 500 may be implemented by the computing device 130 in the example environment 100, for example, may be implemented by a processor or processing unit of the computing device 130, or various function modules of the computing device 130. In other embodiments, the example process 500 may also be implemented by a computing device independent of the example environment 100, or may be implemented by other units or modules in the example environment 100.

FIG. 6 is a schematic diagram of determining first measurement data D(T1) by sampling lane marker data from first road data 115 according to an embodiment of the present disclosure. It is understood that the specific shapes of the lane marker 152 and the reference marker 154 depicted in FIG. 6, and the number of sampled points and other elements are only schematic, and are not intended to limit the scope of the present disclosure in any way. In other embodiments, the lane marker 152 and the reference marker 154 may have any shape, and may have any suitable number of sampled points. In addition, the numbering of the sampled points in FIG. 6 is only schematic. The sampled point numbered 1 is not necessarily the first sampled point, and the sampled point numbered N is not necessarily the last sampling point.

As illustrated in FIGS. 5 and 6, at 510, the computing device 130 may obtain the first lane marker data of the lane marker 152 and the first reference marker data of the reference marker 154 from the first road data 115. As used herein, the first lane marker data refers to any data used to describe the lane marker 152 in the first road data 115, and the first reference marker data refers to any data used to describe the reference marker 154 in the first road data 115. For example, in the case where the first road data 115 is a high-precision map, the computing device 130 may extract the set of coordinate points representing the lane marker 152 and the set of coordinate points representing the reference marker 154 from the high-precision map data of the road 150, namely the first lane marker data and the first reference marker data. In some embodiments, these coordinate points may be represented using latitude and longitude coordinates.

At 520, the computing device 130 may sample the first lane marker data to obtain the first set of sampled points 610-1 to 610-N of the lane marker 152 (collectively referred to as the first set of sampled points 610). In some embodiments, sampling may be performed at a predetermined sampling interval, and the sampling interval may be determined by those skilled in the art according to factors such as specific accuracy requirements and technical environment. For example, in practice, the sampling interval may be set to 1 meter, which is beneficial to achieve a balance between the amount of calculation performed by the computing device 130 and the accuracy of calculation. However, it is understood that this specific value of the sampling interval is only exemplary and is not intended to limit the scope of the present disclosure in any way. In other embodiments, the sampling interval may be any suitable value. More generally, the computing device 130 may also sample the first lane marker data with an uneven sampling interval. In engineering practice, when the first road data 115 is a high-precision map, before sampling the lane marker data, the computing device 130 may also need to obtain the file of the high-precision map, and then import the file of the high-precision map to a database.

At 530, the computing device 130 may determine the distance 615-1 to 615-N (collectively referred to as distance set 615) between the sampled points 610-1 to 610-N in the first set of sampled points 610 and the reference marker 154 based on the first lane marker data and the first reference marker data as the first measurement data D(T1). In other words, the first measurement data D(T1) may include a measured distance from each sampled point of the first lane marker data to the reference marker 154, that is, a set 615 of measured distances that is the same number as the number of the sampled points. It is noted that although in the example of FIG. 6, the computing device 130 samples the first lane marker data to determine the first measurement data D(T1), in other embodiments, the computing device 130 may also sample the first reference marker data and then calculate the distance between the sampled point of the first reference marker data to the lane marker 152 to determine the first measurement data D(T1).

Through the example process 500, the computing device 130 can obtain a set of distances between a limited number of sampled points and the reference marker 154 by sampling, and determine the set of distances as the first measurement data D(T1). Therefore, the process of determining the first measurement data D(T1) by the computing device 130 can be simplified and has strong operability. In addition, by adjusting the sampling interval, the computing device 130 can also adjust the accuracy of the first measurement data D(T1).

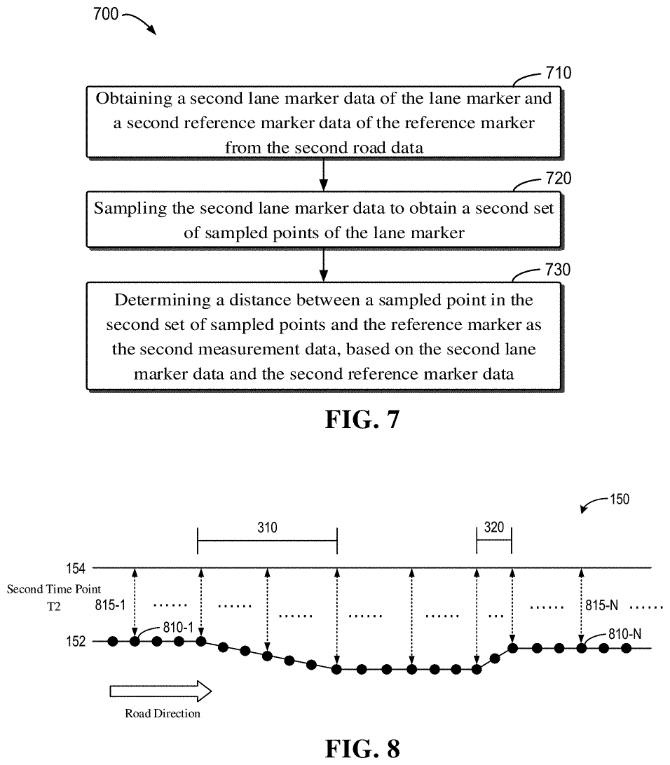

Similarly, as mentioned above when describing the block 220 of the example process 200, the second road data 125 collected by the low-precision device 120 on the road 150 may not directly include the second measurement data D(T2) between the lane marker 152 and the reference marker 154. For example, the second road data 125 may be a video recorded by the low-precision device 120 that presents the lane marker 152 and the reference marker 154, and thus does not directly include distance data between the lane marker 152 and the reference marker 154. In this case, the computing device 130 may derive or calculate the second measurement data D(T2) from the second road data 125. Such examples are described below with reference to FIGS. 7 and 8.

FIG. 7 is a flowchart of an example process 700 of obtaining second measurement data D(T2) from second road data 125 according to an embodiment of the present disclosure. In some embodiments, the example process 700 may be implemented by the computing device 130 in the example environment 100, for example, may be implemented by a processor or processing unit of the computing device 130, or various function modules of the computing device 130. In other embodiments, the example process 700 may also be implemented by a computing device independent of the example environment 100, or may be implemented by other units or modules in the example environment 100.

FIG. 8 is a schematic diagram of determining second measurement data D(T2) by sampling lane marker data from second road data 125 according to an embodiment of the present disclosure. It is understood that the specific shapes of the lane marker 152 and the reference marker 154 depicted in FIG. 8, and the number of sampled points and other elements are only schematic, and are not intended to limit the scope of the present disclosure in any way. In other embodiments, the lane marker 152 and the reference marker 154 may have any shape, and may have any suitable number of sampled points. In addition, the number of the sampled points in FIG. 8 is only schematic, the sampled point numbered 1 is not necessarily the first sampled point, and the sampled point numbered N is not necessarily the last sampled point.

As illustrated in FIGS. 7 and 8, at 710, the computing device 130 may obtain the second lane marker data of the lane marker 152 and the second reference marker data of the reference marker 154 from the second road data 125. As used herein, the second lane marker data refers to any data used to describe the lane marker 152 in the second road data 125, and the second reference marker data refers to any data used to describe the reference marker 154 in the second road data 125.

For example, if the second road data 125 is a video collected by a drive recorder, the computing device 130 may extract a set of coordinate points representing the lane marker 152 and a set of coordinate points representing the reference marker 154 from the video of the road 150, i.e., the second lane marker data and the second reference marker data. In this process, the computing device 130 may refer to and use the first road data 115 of the road 150 or the position data of the low-precision device 120, and various shooting parameters of the low-precision device 120, such as internal and external parameters of the camera. In other embodiments, the computing device 130 may also determine the second lane marker data and the second reference marker data by extracting the sampled points of the lane marker 152 and the reference marker 154 from the frame of the video of the road 150. Such examples are described further below.

At 720, the computing device 130 may sample the second lane marker data to obtain the second set of sampled points 810-1 to 810-N of the lane marker (collectively referred to as the second set of sampled points 810). In some embodiments, sampling may be performed at a predetermined sampling interval, and the sampling interval may be determined by those skilled in the art according to factors such as specific accuracy requirements and technical environment. For example, in practice, the sampling interval may be set to 1 meter, which is beneficial to achieve a balance between the amount of calculation performed by the computing device 130 and the accuracy of calculation. However, it is understood that this specific value of the sampling interval is only exemplary and is not intended to limit the scope of the present disclosure in any way. In other embodiments, the sampling interval may be any suitable value.

Generally, the computing device 130 may also sample the second lane marker data with an uneven sampling interval. In addition, in some embodiments, the sampling interval for the second lane marker data may be the same as the sampling interval for the first lane marker, which is beneficial to simplify the entire processing process of the first and second lane marker data. However, in other embodiments, the sampling interval of the second lane marker data may also be different from the sampling interval of the first lane marker data, which is beneficial to select proper sampling interval respectively according to the specific circumstances of the first and second lane marker data.

At 730, the computing device 130 may determine distance 815-1 to 815-N (collectively referred to as the distance set 815) between the sampled points 810-1 to 810-N and the reference marker 154 in the second set of sampled points 810 based on the second lane marker data and the second reference marker data, as the second measurement data D(T2). In other words, the second measurement data D(T2) may include measured distances between each sampled point on the second lane marker data to the reference marker 154, that is, a set 815 of measured distances where the number of the measured distances is identical to the number of sampled points. It is noted that although in the example of FIG. 8, the computing device 130 samples the second lane marker data to determine the second measurement data D(T2), in other embodiments, the computing device 130 samples the second reference marker data, and then calculate the distances between the sampled points of the second reference marker data to the lane marker 152 to determine the second measurement data D(T2).

Through the example process 700, the computing device 130 can obtain the distance between a limited number of sampled points and the reference marker 154 by using a sampling method, and determine the distance as the second measurement data D(T2). Therefore, the processing of the computing device 130 for determining the second measurement data D(T2) can be simplified and has strong operability. In addition, by adjusting the sampling interval, the computing device 130 adjusts the accuracy of the second measurement data D (T2).

Example Process of Obtaining Lane Marker Data and Reference Marker Data from Second Road Data

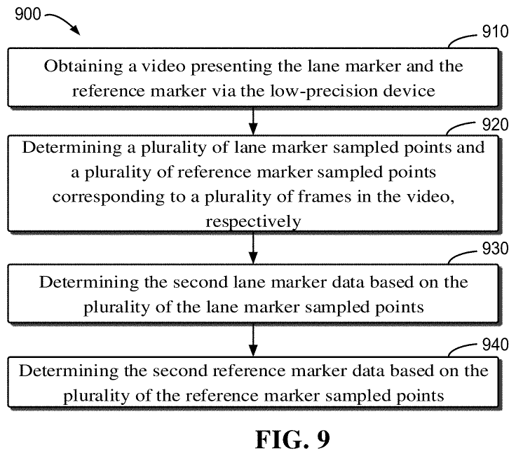

As mentioned above when describing the block 710 of the example process 700, the computing device 130 may also extract the sampled points of the lane marker 152 and the reference marker 154 from the frame of the video of the road 150 taken by the low-precision device 120 to determine the first lane marker data and the first reference marker data. Such examples are described below with reference to FIGS. 9 to 11.

FIG. 9 is a flowchart of an example process 900 of obtaining second lane marker data and second reference marker data from second road data 125 according to an embodiment of the present disclosure. In some embodiments, the example process 900 may be implemented by the computing device 130 in the example environment 100, for example, may be implemented by a processor or processing unit of the computing device 130, or various function modules of the computing device 130. In other embodiments, the example process 900 may also be implemented by a computing device independent of the example environment 100, or may be implemented by other units or modules in the example environment 100.

At 910, the computing device 130 may obtain a video presenting the lane marker 152 and the reference marker 154 from the low-precision device 120. For example, in the case where the low-precision device 120 is a drive recorder, the computing device 130 may obtain video captured by the drive recorder when the vehicle installed with the drive recorder travels on the road 150. It is appreciated that the computing device 130 may obtain the video presenting the lane marker 152 and the reference marker 154 from the low-precision device 120 in any suitable manner. For example, the computing device 130 may select a video presenting the lane marker 152 and the reference marker 154 from the videos taken by the low-precision device 120 within a unit time (e.g., 1 day). For another example, the user of the drive recorder may select or set to transmit the video presenting the lane marker 152 and the reference marker 154 to the computing device 130.

At 920, the computing device 130 may determine a plurality of lane marker sampled points and reference marker sampled points corresponding to the plurality of frames in the video presenting the lane marker 152 and the reference marker 154, respectively. For example, the computing device 130 may extract the plurality of frames from the above video, and each frame is an image in which the lane marker 152 and the reference marker 154 are presented. Then, in each frame of the plurality of frames, the computing device 130 may select the lane marker sampled points and the reference marker sampled points on the image corresponding to the lane marker 152 and the reference marker 154 in the frame. In this way, the computing device 130 can obtain the plurality of lane marker sampled points and the reference marker sampled points respectively corresponding to a plurality of frames. In addition, it is understood that the selection of one sampled point in each frame is merely exemplary, and is not intended to limit the scope of the present disclosure in any way. In other embodiments, the computing device 130 may also select a plurality of sampled points in each frame.

Generally, the computing device 130 may select any proper lane marker sampled points and reference marker sampled points on the image of the lane marker 152 and the reference marker 154 in each frame for fitting the second lane marker data and the second reference marker data in subsequent process. However, in some embodiments, in each frame, the computing device 130 may select the plurality of the lane marker sampled points and the reference marker sampled points at a fixed distance relative to the low-precision device 120, which is advantageous for simplifying the process of selecting the lane marker sampled points and the reference marker sampled points by the computing device 130, and thereby improving the accuracy of the finally extracted second lane marker data and the second reference marker data. Such examples are described further below.

At 930, the computing device 130 may determine the second lane marker data based on the plurality of the lane marker sampled points from the plurality of frames. For example, the computing device 130 may fit the plurality of the lane marker sampled points from different frames into one lane marker as the second lane marker data. In some cases, during the process of fitting the lane marker, the computing device 130 may need to obtain the coordinate positions of the sampled points of each lane marker, such as latitude and longitude coordinates. In engineering practice, before fitting the lane marker, the computing device 130 may also remove abnormal points where the measured distance between the sampled point of the lane marker and the reference marker 154 significantly deviates from the true value.

In addition, the coordinate positions of the lane marker sampled points are determined in any suitable manner. For example, the computing device 130 may first determine the latitude and longitude coordinates of a certain position in the image frame according to the first road data 115 collected by the high-precision device 110. Then, the computing device 130 may determine the coordinate positions of the lane marker sampled points based on the position, the relative position relation of the lane marker sampled points in the image frame, the internal and external parameters of the camera of the low-precision device 120 that captured the image frame. For example, the computing device 130 may obtain the coordinate position when the image frame is captured from the positioning system of the vehicle installed with the low-precision device 120 or from the own positioning module of the low-precision device 120, thereby determining the coordinate position of the lane marker sampled point.

At 940, the computing device 130 may determine the second reference marker data based on the plurality of the reference marker sampled points from the plurality of frames. For example, the computing device 130 may fit the plurality of the reference marker sampled points from different frames into one reference marker as the second reference marker data. In some cases, during the process of fitting the reference marker, the computing device 130 may need to obtain the coordinate position of each reference marker sampled point, such as the latitude and longitude coordinates. In engineering practice, before fitting the reference marker, the computing device 130 also excludes the abnormal point where the measured distance between the reference marker sampled point and the lane marker 152 deviates significantly from the true value. In some embodiments, the computing device 130 may determine the position coordinates of the reference marker sampled points in the same manner as for the lane marker sampled points. Alternatively, the computing device 130 may also obtain the position coordinates of the reference marker sampled points in a different way from the way used for the lane marker sampled point.

Through the example process 900, the processing procedure of the computing device 130 to determine the second lane marker data and the second reference marker data can be simplified. In addition, by adjusting the number of frames extracted from the video presenting the lane marker 152 and the reference marker 154 and the number of the lane marker sampled points and the reference marker sampled points selected in each frame, the computing device 130 also adjusts the resulting the accuracy of the second lane marker data and the second reference marker data.

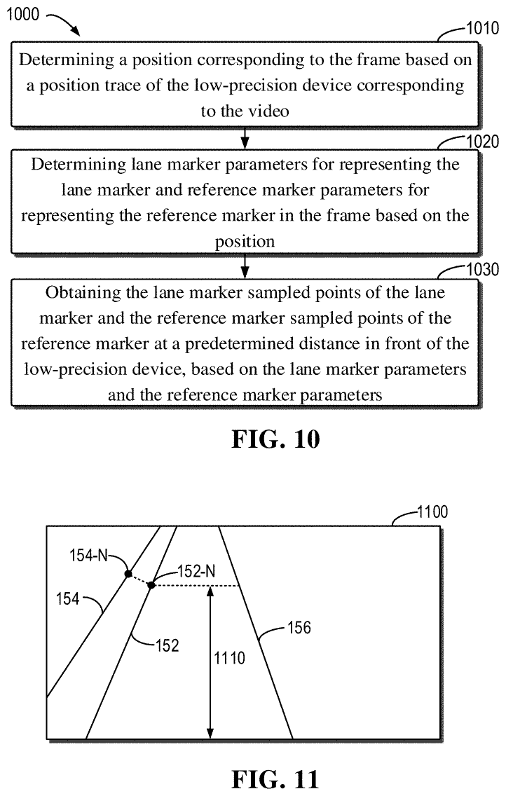

As mentioned above when describing a block 920 of the example process 900, in each frame, the computing device 130 may select the lane marker sampled points and the reference marker sampled points at a fixed distance relative to the low-precision device 120. Such an example is described below with reference to FIGS. 10 and 11.

FIG. 10 is a flowchart of an example process 1000 of determining lane marker sampled points and reference marker sampled points from a video frame that presents the lane marker 152 and the reference marker 154 according to an embodiment of the present disclosure. In some embodiments, the example process 1000 may be implemented by the computing device 130 in the example environment 100, for example, may be implemented by a processor or processing unit of the computing device 130, or various function modules of the computing device 130. In other embodiments, the example process 1000 may also be implemented by a computing device independent of the example environment 100, or may be implemented by other units or modules in the example environment 100.

FIG. 11 is a schematic diagram of determining a lane marker sampled point and a reference marker sampled point in a video frame 1100 according to an embodiment of the present disclosure. As illustrated in FIG. 11, in the video frame 1100 of the road 150 taken by the low-precision device 120, the lane marker 152, the reference marker 154 as the roadside marker, and another lane formed by the lane marker 156 and the lane marker 152. It is understood that the specific shapes and extension directions of the lane marker 152, the reference marker 154, and the lane marker 156 depicted in FIG. 11 are merely schematic, and are not intended to limit the scope of the present disclosure in any way. In other embodiments, the lane marker 152, the reference marker 154, and the lane marker 156 may have any suitable shape and extend in proper direction.

As illustrated in FIGS. 10 and 11, for each frame (e.g., frame 1100) of the video taken from the low-precision device 120, at 1010, the computing device 130 may determine the position of the frame 1100 based on position trajectory of the low-precision device 120. For example, in the case where the low-precision device 120 is an on-board drive recorder, the computing device 130 may obtain positioning data corresponding to the above-mentioned video (e.g., GPS trajectory of the global satellite positioning system) from a vehicle installed with the drive recorder. For example, in some cases, the low-precision device 120 as a drive recorder may also have a satellite positioning module (for example, a low-precision GPS module). In this case, the computing device 130 may directly obtain the above-mentioned video and associated satellite positioning data (e.g., GPS trajectory) from the low-precision device 120.

After obtaining the satellite positioning data associated with the above video, the computing device 130 may, for example, use a method of interpolation in the satellite positioning data (e.g., GPS trajectory) to determine the position of the low-precision device 120 corresponding to the frame 1100. However, it is understood that the computing device 130 may also use any other suitable way to determine the location information corresponding to the frame 1100. For example, the computing device 130 may first determine a time stamp when the low-precision device 120 took the frame 1100, and then determine the position of the low-precision device 120 corresponding to the time stamp in the satellite positioning data.

At 1020, the computing device 130 may determine the lane marker parameters and the reference marker parameters used to represent the lane marker 152 and the reference marker 154 in the frame 1100 based on the position of the frame 1100, respectively. For example, based on the position of the frame 1100 and the relative position of the lane marker 152 and the reference marker 154 presented in the frame 1100, the computing device 130 obtains the lane marker parameters for describing the lane marker 152 and the reference marker parameters for describing the reference marker 154. In some embodiments, the lane marker parameters may be parameters describing a lane marker equation of the lane marker 152 (e.g., a cubic equation), and the reference marker parameters may be parameters describing a reference marker equation of the reference marker 154 (e.g., a cubic equation). In some embodiments, the computing device 130 may determine the lane marker parameters of the lane marker 152 and the reference marker parameters of the reference marker 154 through a perception algorithm module of the lane marker and the reference marker. In addition, in engineering practice, the computing device 130 may also perform distortion correction on the image frame 1100 according to the internal parameters of the camera of the low-precision device 120 to improve the accuracy of the lane marker parameters and the reference marker parameters.

At 1030, the computing device 130 may obtain a lane marker sampled point 152-N of the lane marker 152 and a reference marker sampled point 154-N of the reference marker 154 at a predetermined distance 1110 in front of the low-precision device 120 based on the lane marker parameters and the reference marker parameters. In other words, according to the lane marker parameters and the reference marker parameters, the computing device 130 may determine the position of each point on the lane marker 152 and the reference marker 154 in the frame 1100. Therefore, the computing device 130 may determine the lane marker sampled point 152-N and the reference marker sampled point 154-N at a predetermined distance 1110 in front of the low-precision device 120 through calculation.

In some embodiments, the predetermined distance 1110 may be set to 10 meters. However, it is understood that those skilled in the art can reasonably set the specific value of the predetermined distance 1110 according to the specific accuracy requirements and technical environment. Next, the computing device 130 may determine the plurality of the lane marker sampled points from the plurality of frames in the video of the low-precision device 120 for fitting the lane marker as the second lane marker data, and the plurality of the reference marker sampled points to fit the reference marker as the second reference marker data.

Through the example process 1000, the computing device 130 can select the lane marker sampled points and the reference marker sampled points from each frame in an efficient and consistent manner, thereby improving the accuracy of the lane markers and the reference markers finally obtained by fitting.

### Example Process for Determining Changed Region

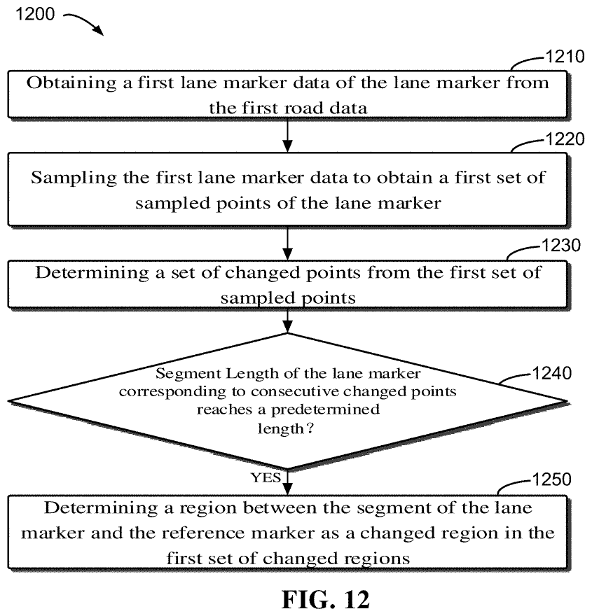

As mentioned above when describing the block 210 of the example process 200, the computing device 130 may determine the first set of changed regions based on the way the lane marker data of the lane marker 152 is sampled. Such examples are described below with reference to FIGS. 12 to 14.

FIG. 12 is a flowchart of an example process 1200 of determining a changed region from first road data 115 according to an embodiment of the present disclosure. In some embodiments, the example process 1200 may be implemented by the computing device 130 in the example environment 100, for example, may be implemented by a processor or processing unit of the computing device 130, or by various function modules of the computing device 130. In other embodiments, the example process 1200 may also be implemented by a computing device independent of the example environment 100, or may be implemented by other units or modules in the example environment 100.

At 1210, the computing device 130 may obtain the first lane marker data of the lane marker 152 from the first road data 115. As described above, the first lane marker data refers to any data used to describe the lane marker 152 in the first road data 115. For example, in the case where the first road data 115 is a high-precision map, the computing device 130 may extract the set of coordinate points representing the lane marker 152 from the high-precision map data of the road 150, i.e., the first lane marker data. In some embodiments, these coordinate points may be represented using latitude and longitude coordinates. It is understood that depending on the specific form of the first road data 115, the computing device 130 may obtain the first lane marker data of the lane marker 152 in other proper manners.

At 1220, the computing device 130 may sample the first lane marker data to obtain a first set of sampled points for the lane marker. As described above, in some embodiments, sampling may be performed at a predetermined sampling interval, and the sampling interval may be determined by those skilled in the art according to specific accuracy requirements and other factors. For example, in practice, the sampling interval may be set to 1 meter, which is beneficial to achieve a balance between the amount of calculation performed by the computing device 130 and the accuracy of calculation. However, it is understood that this specific value of the sampling interval is only exemplary and is not intended to limit the scope of the present disclosure in any way. In other embodiments, the sampling interval may be any suitable value. Generally, the computing device 130 may also sample the first lane marker data with an uneven sampling interval.

At 1230, the computing device 130 may determine a set of changed points from the first set of sampling points. As used herein, a changed point refers to a sampled point at which the distance D between the lane marker 152 and the reference marker 154 changes before and after the sampled point. Therefore, in some embodiments, for a certain sampled point, the computing device 130 may determine the distance between the sampled point before the sampled point and the reference marker 154, and then determine the distance between the sampled point after the sampled point and the reference marker 154. If the distance between the front sampled point and the reference marker 154 and the distance between the rear sampled point and the reference marker 154 are different, the computing device 130 may determine the sampled point as a changed point.

However, as noted above, in practice, there may be errors in drawing the lane marker 152 and the reference marker 154 (e.g., the roadside marker). In such cases, if only changes of one sampled point before the sampled point and one sampled point after a certain sampled point is considered, it may lead to an excessive number of changed points, and most of the changed points are not effective changed points in practice, that is, the changed points have no practical meaning. Based on such considerations, in some embodiments, for a certain sampled point, the computing device 130 may determine an average value of distances between the plurality of sampled points in the front and the reference marker 154 and distances between the plurality of sampled points in the rear and the reference marker 154 to determine the changed point. Such examples are described further below.

At 1240, the computing device 130 may determine whether a length of a segment of the lane marker corresponding to a plurality of consecutive changed points in the above set of changed points reaches a predetermined length, in which the predetermined length is the predetermined length for determining the “significant” changed region described above. In other words, if all the sampled points on a segment of the lane marker whose length reaches the predetermined length are changed points, the computing device 130 may consider the plurality of changed points to be practically meaningful changed points. If the lengths of the lane markers segment corresponding to the plurality of changed points do not reach the predetermined length, the computing device 130 may consider these changed points to be caused due to measurement errors.

In practice, the predetermined length may be set by those skilled in the art according to specific accuracy requirements and technical environment. For example, the predetermined length may be 20 meters. Therefore, in the case where the sampling interval is 1 meter, the number of consecutive changed points reaches 20 before it is considered effective by the computing device 130. It is understood that the specific numbers listed here are merely exemplary and are not intended to limit the scope of the present disclosure in any way. In other embodiments, the above-mentioned predetermined length may be any proper length, and the number of consecutive changing points may vary depending on the predetermined length and sampling interval.

At 1250, if the computing device 130 determines that the lengths of the segment of the lane marker corresponding to the consecutive plurality of changed points reaches the predetermined length, the computing device 130 may determine the area between the segment of the lane marker and the reference marker 154 as a changed region in the first set of changed regions. In this way, the computing device 130 excludes changed regions of short length that may not have practical meaning in practice, thereby simplifying the processing process of the computing device 130 to determine the changed regions, meanwhile improving the identifying efficiency of the effective changed regions. In engineering practice, before determining the changed regions, the computing device 130 may also perform quality inspection, audit, and storage operations on the determined changed points. For the determined changed region, manual review and storage are performed.

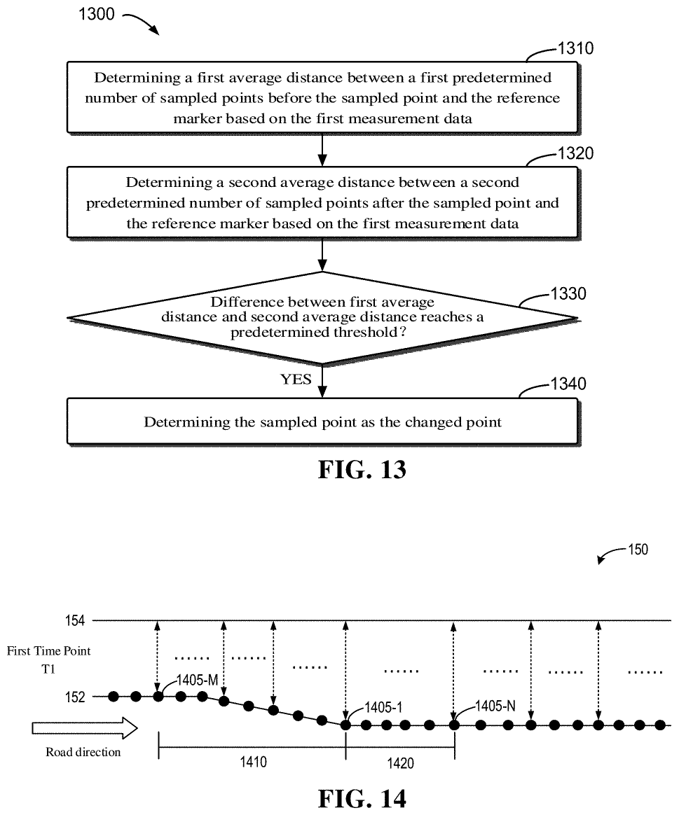

As mentioned above in the description of the block 1230 of the example process 1200, for a certain sampled point, the computing device 130 may determine the average value of the distances between the plurality of sampled points in the front and the reference marker 154 and the distances between the plurality of sampled points in the rear and the reference marker 154 to determine the changed point. Hereinafter, such an example is described with reference to FIGS. 13 and 14.

FIG. 13 is a flowchart of an example process 1300 of determining a changed point based on first measurement data 115 according to an embodiment of the present disclosure. In some embodiments, the example process 1300 may be implemented by the computing device 130 in the example environment 100, for example, may be implemented by a processor or processing unit of the computing device 130, or various function modules of the computing device 130. In other embodiments, the example process 1300 may also be implemented by a computing device independent of the example environment 100, or may be implemented by other units or modules in the example environment 100.

FIG. 14 is a schematic diagram of determining a changed point 1405-1 based on first measurement data 115 according to an embodiment of the present disclosure. It is understood that the specific shapes of the lane marker 152 and the reference marker 154 depicted in FIG. 14, and the number of sampled points and other elements are only schematic, and are not intended to limit the scope of the present disclosure in any way. In other embodiments, the lane marker 152 and the reference marker 154 may have any shape, and may have any suitable number of sampled points. In addition, it is noted that, for simplicity of description, the sampled points in FIG. 14 are not sequentially numbered from left to right, but are numbered on both sides centering on the sampled point.

As illustrated in FIGS. 13 and 14, for each sampled point in the first set of sampled points (e.g., the sampled point 1405-1), at 1310, the computing device 130 may determine the first average distance of distances between the first predetermined number (e.g., M) of sampled points 1405-M to 1405-1 and the reference marker 154 based on the first measurement data D(T1) of the distance D between the lane marker 152 and the reference marker 154, that is, the average distance between a segment of the lane marker 1410 and the reference marker 154. In some embodiments, the sampled point before the sampled point 1405-1 here refers to the sampled point after the sampled point 1405-1 along the road direction.

At 1320, the computing device 130 may determine a second average distance of distances between a second predetermined number (e.g., N) of sampled points 1405-1 to 1405-N after the sampled point 1405-1 and the reference marker 154 based on the first measurement data D(T1), that is, the average distance between the segment of the lane marker 1420 and the reference marker 154. In some embodiments, the sampled point after the sampled point 1405-1 here refers to the sampled point before the sampled point 1405-1 along the road direction.

At 1330, the computing device 130 may determine whether the difference between the first average distance and the second average distance reaches a predetermined threshold. In practice, the predetermined threshold is set by those skilled in the art according to specific accuracy requirements and technical environment. In some embodiments, the predetermined threshold may be equal to the variation threshold for determining the “significant” changed region described above, for example, the predetermined threshold may be 0.2 meters. It is understood that the specific values listed here are only examples and are not intended to limit the scope of the present disclosure in any way. In other embodiments, the predetermined threshold may be set to any proper value.

At 1340, if it is determined that the difference between the first average distance and the second average distance reaches the predetermined threshold, the computing device 130 may determine the sampled point as the changed point. In other words, if the above-mentioned difference reaches the predetermined threshold, the computing device 130 considers the sampled point as the changed point. Otherwise, if the above difference does not reach the predetermined threshold, the computing device 130 may not consider the sampled point to be the changed point, and the difference between the distance D before and after the sampled point is caused due to measurement errors or other interference factors. In this way, the difference between the average value of the distances between the plurality of the sampled points before the sampled point and the reference marker and the distances between the plurality of the sampled points after the sampled point and the reference marker is used to determine whether the sampled point is the changed point, thereby eliminating impact of other errors such as sudden changes in measurement data on the determination of changed points, and improving the accuracy of identifying changed points.

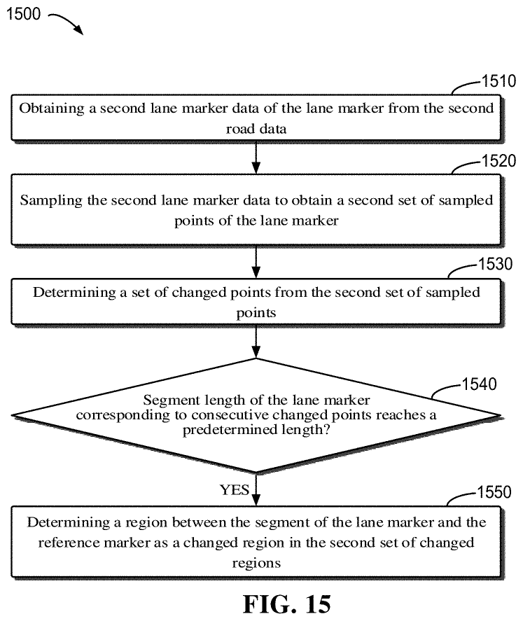

Similar to the processing of the first road data 115, as mentioned above when describing the block 220 of the example process 200, the computing device 130 may determine the second set of changed regions based on the way the lane marker data of the lane marker 152 is sampled. Such examples are described below with reference to FIGS. 15 to 17.

FIG. 15 is a flowchart of an example process 1500 of determining a changed region from second road data 125 according to an embodiment of the present disclosure. In some embodiments, the example process 1500 may be implemented by the computing device 130 in the example environment 100, for example, may be implemented by a processor or processing unit of the computing device 130, or various function modules of the computing device 130. In other embodiments, the example process 1500 may also be implemented by a computing device independent of the example environment 100, or may be implemented by other units or modules in the example environment 100.

At 1510, the computing device 130 may obtain the second lane marker data of the lane marker 152 from the second road data 125. As described above, the second lane marker data refers to any data used to describe the lane marker 152 in the second road data 125. For example, in the case where the second road data 125 is a video taken by the low-precision device 120, the computing device 130 may extract the set of coordinate points representing the lane marker 152 from the video of the road 150, that is, the second lane marker data. In some embodiments, these coordinate points may be represented using latitude and longitude coordinates. It is understood that, depending on the specific form of the second road data 125, the computing device 130 may obtain the second lane marker data of the lane marker 152 in other proper manners.

At 1520, the computing device 130 may sample the second lane marker data to obtain the second set of sampled points of the lane marker. As described above, in some embodiments, sampling may be performed at a predetermined sampling interval, and the sampling interval may be determined by those skilled in the art according to specific accuracy requirements and other factors. For example, in practice, the sampling interval may be set to 1 meter, which is beneficial to achieve a balance between the amount of calculation performed by the computing device 130 and the calculation accuracy. However, it is understood that this specific value of the sampling interval is only illustrative and is not intended to limit the scope of the present disclosure in any way. In other embodiments, the sampling interval may be any proper value. More generally, the computing device 130 may also sample the second lane marker data at an uneven sampling interval.

At 1530, the computing device 130 may determine a set of changed points from the second set of sampling points. As used herein, the changed point refers to the sampled point at which the distance D between the lane marker 152 and the reference marker 154 changes before and after the sampled point. Therefore, in some embodiments, for the sampled point, the computing device 130 may determine the distance between a sampled point before the sampled point and the reference marker 154, and then determine the distance between the sampled point after the sampled point and the reference marker 154. If the distance between the front sampled point and the reference marker 154 is different to the distance between the rear sampled point and the reference marker 154, the computing device 130 may determine the sampled point as the changed point.

However, as noted above, in practice, there may be errors in drawing the lane marker 152 and the reference marker 154 (e.g., the roadside marker). In addition, the measurement data measured by the low-precision device 120 also has instability, for example, hopping may occur on the measurement value. In such cases, if only the change of one sampled point before and after a certain sampled point is considered, it may lead to an excessive number of changed points, and most of the changed points are not effective changed points in practice, that is, those changed points have no practical meaning. Based on such considerations, in some embodiments, for a certain sampled point, the computing device 130 may determine an average value of distances between the plurality of sampled points in the front and the reference marker 154 and distances between the plurality of sampled points in the rear and the reference marker 154 to determine the changed point. Such examples are described further below.

At 1540, the computing device 130 may determine whether the lengths of the segment of the lane marker corresponding to the plurality of consecutive changed points in the set of changed points reaches the predetermined length, where the predetermined length is used to determine the predetermined length of the “significant” changed regions. In other words, if all the sampled points of the segment of the lane marker whose length reaches the predetermined length are changed points, the computing device 130 may consider the plurality of the changed points to be practically meaningful changed points. If the lengths of the segment of the lane marker corresponding to the plurality of the changed points does not reach the predetermined length, the computing device 130 may consider these changed points to be caused due to measurement errors.

In practice, the predetermined length may be set by those skilled in the art according to specific accuracy requirements and technical environment. For example, the predetermined length may be 20 meters. Therefore, in the case where the sampling interval is 1 meter, the number of consecutive changed points needs to reach 20 before it is considered effective by the computing device 130. It is understood that the specific numbers listed here are merely exemplary and are not intended to limit the scope of the present disclosure in any way. In other embodiments, the above-mentioned predetermined length may be any appropriate length, and the number of consecutive changing points may also vary depending on the predetermined length and the sampling interval.

At 1550, if the computing device 130 determines that the lengths of the segment of the lane marker corresponding to the plurality of consecutive changed points reach the predetermined length, the computing device 130 may determine the area between the segment of the lane marker and the reference marker as the second set of changed regions. In this way, the computing device 130 excludes changed regions of short length that may not have practical meaning in practice, thereby simplifying the processing process of the computing device 130 to determine the changed regions, meanwhile improving the identifying efficiency of the effective changed regions. In engineering practice, before determining the changed regions, the computing device 130 may also perform quality inspection, audit, and storage operations on the determined changed points. For the determined changed region, manual review and storage are performed.

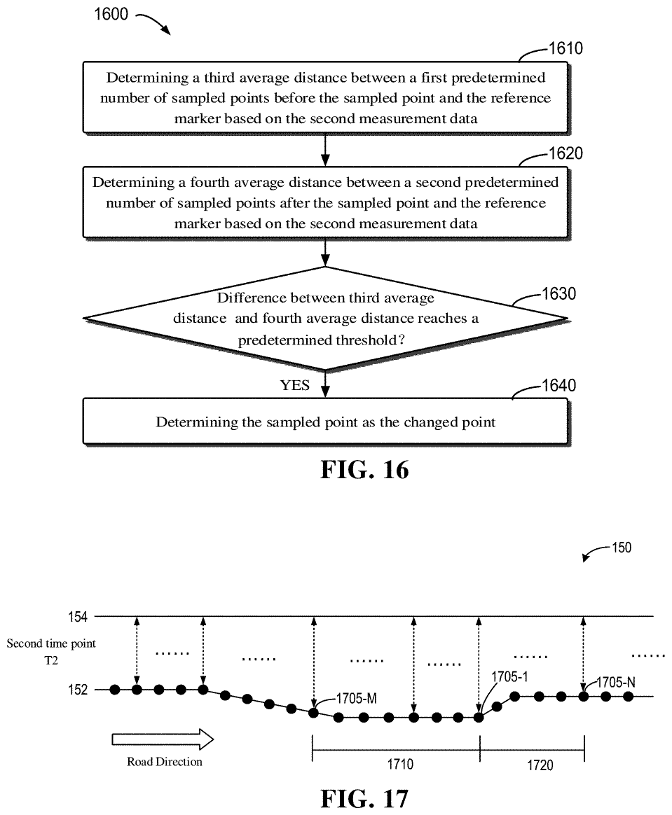

As mentioned above in the description of the block 1530 of the example process 1500, for a certain sampled point, the computing device 130 may determine an average value of distances between the plurality of sampled points in the front and the reference marker 154 and distances between the plurality of sampled points in the rear and the reference marker 154 to determine the changed point. Such examples are described further below with reference to FIGS. 16 and 17.

FIG. 16 is a flowchart of an example process 1600 of determining a changed point based on second measurement data 125 according to an embodiment of the present disclosure. In some embodiments, the example process 1600 may be implemented by the computing device 130 in the example environment 100, for example, by a processor or processing unit of the computing device 130, or by various function modules of the computing device 130. In other embodiments, the example process 1600 may also be implemented by a computing device independent of the example environment 100, or may be implemented by other units or modules in the example environment 100.

FIG. 17 is a schematic diagram of determining a changed point 1705-1 based on second measurement data 125 according to an embodiment of the present disclosure. It is understood that the specific shapes of the lane marker 152 and the reference marker 154 depicted in FIG. 17, as well as the number of the sampled points, are only schematic, and are not intended to limit the scope of the present disclosure in any way. In other embodiments, the lane marker 152 and the reference marker 154 may have any shape, and may have any suitable number of sampled points. In addition, it is noted that, for simplicity of description, the sampled points in FIG. 17 are not sequentially numbered from left to right, but are numbered on both sides with the sampled point as the center.

As illustrated in FIGS. 16 and 17, for each sampled point in the second set of sampled points (e.g., the sampled point 1705-1), at 1610, the computing device 130 may determine the third average distance of distances between the first predetermined number (e.g., M) of sampled points 1705-1 to 1705-M before the sampled point 1705-1 and the reference marker 154, i.e., an average distance between the segment of the lane marker 1710 and the reference marker 154 based on the second measurement data D(T2) of the distance D between the lane marker 152 and the reference marker 154. In some embodiments, the sampled point before the sampled point 1705-1 here refers to the sampled point after the sampled point 1705-1 along the road direction.

At 1630, the computing device 130 may determine whether the difference between the third average distance and the fourth average distance reaches a predetermined threshold. In practice, the predetermined threshold can be set by those skilled in the art according to specific accuracy requirements and technical environment. In some embodiments, the predetermined threshold may be equal to the variation threshold for determining the “significant” changed regions described above, for example, the predetermined threshold may be 0.2 meters. It is understood that the specific values listed here are only examples and are not intended to limit the scope of the present disclosure in any way. In other embodiments, the predetermined threshold may be set to any proper value.

At 1640, if it is determined that the difference between the third average distance and the fourth average distance reaches the predetermined threshold, the computing device 130 may determine the sampled point as the changed point. In other words, if the above-mentioned difference reaches the predetermined threshold, the computing device 130 considers the sampled point as the changed point. Otherwise, if the above difference does not reach the predetermined threshold, the computing device 130 may not consider the sampled point to be the changed point, but the difference between the distance D before and after the sampled point is caused due to measurement errors or other interference factors. In this way, the difference between the average value of the distance between the plurality of sampled points before the sampled point and the reference marker and the distance between the plurality of sampled points after the sampled point and the reference marker is used to determine whether the sampled point is the changed point, thereby eliminating impact of other errors such as sudden changes in measurement data on the determination of changed points, and improving the accuracy of identifying changed points.

### Example Process for Correcting Second Measurement Data

As noted above, although the low-precision device 120 (e.g., crowd-sourcing device) recognize the change in lane width, due to the internal and external parameters such as shadows and occlusions, a large error is caused between the recognized lane width and the true value. In addition, for the same lane, the lane widths measured by different low-precision devices may also be different, and the lane widths measured by the same low-precision device at different times may also be different. Therefore, the changed region recognized by the low-precision device 120 may not be accurately compared with the changed region recognized by the high-precision device 110.

Therefore, in some embodiments, in order to improve the accuracy of the identified changed region, and the accuracy of the detected position change of the lane marker, the computing device 130 may use the first measurement data D(T1) to correct the second measurement data D(T2) from the low-precision device 120. Generally, the computing device 130 may correct the second measurement data D(T2) in any suitable manner. For example, the computing device 130 may calculate the ratio of the value of the first measurement data D(T1) to the value of the second measurement data D(T2) at a certain coordinate position. The computing device 130 use the ratio to correct the second measurement data D(T2).

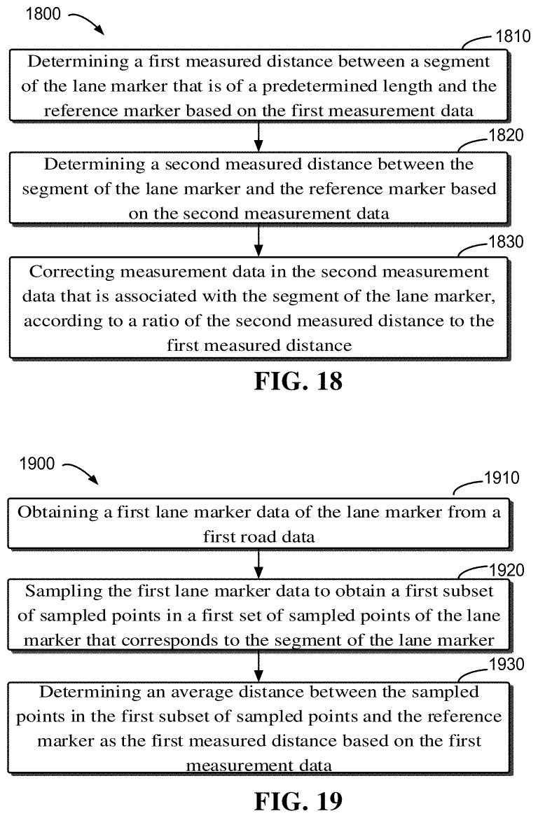

For example, the computing device 130 may calculate the ratio of the average value of the first measurement data D(T1) to the average value of the second measurement data D(T2) over the entire road 150. Then, the computing device 130 may use the ratio of the average value to correct the second measurement data D(T2). In other embodiments, the computing device 130 may also correct the second measurement data D(T2) based on a road segment of a predetermined length of the road 150 (a segment of the lane marker of a predetermined length of the lane marker 152). Hereinafter, such an example is described with reference to FIGS. 18 to 22.

FIG. 18 is a flowchart of an example process 1800 of correcting second measurement data D(T2) by using first measurement data D(T1) according to an embodiment of the present disclosure. In some embodiments, the example process 1800 may be implemented by the computing device 130 in the example environment 100, for example, may be implemented by a processor or processing unit of the computing device 130, or by various function modules of the computing device 130. In other embodiments, the example process 1800 may also be implemented by a computing device independent of the example environment 100, or may be implemented by other units or modules in the example environment 100.

At 1810, the computing device 130 may determine the first measured distance between the segment of the lane marker of the predetermined length of the lane marker 152 and the reference marker 154 based on the first measurement data D(T1), denoted dl below. The predetermined length here is determined by those skilled in the art according to factors such as required measurement accuracy and calculation amount. For example, in some embodiments, the lane segment of the predetermined length may be 60 meters. It is understood that the specific values of the predetermined length listed here are only exemplary and are not intended to limit the scope of the present disclosure in any way. In other embodiments, the computing device 130 may set the segment of the lane marker for correction purposes to any suitable predetermined length. In some embodiments, the segment of the lane marker used for correction purposes are selected as the segment of the lane marker where the distance D between the lane marker 152 and the reference marker 154 is substantially constant, also referred to herein as “distance stability segment”.

In addition, the computing device 130 may determine the first measured distance d1 in any suitable manner, which may depend on the position relation between the segment of the lane marker and the reference marker 154. For example, in the case where the segment of the lane marker is parallel to the reference marker 154, the computing device 130 may find the distance between any point on the segment of the lane marker and the reference marker from the first measurement data. If the distance between the segment of the lane marker and the reference marker varies, the computing device 130 may determine the distance D between the lane marker 152 and the reference marker 154 in the area associated with the segment of the lane marker based on the average value of the first measurement data D(T1). For example, the computing device 130 may also determine the first measured distance d1 by sampling the segment of the lane marker. Such examples are described further below.

At 1820, the computing device 130 may determine the second measured distance between the segment of the lane marker and the reference marker 154 based on the second measurement data D(T2), hereinafter referred to as d2. Similarly, at block 1810, the computing device 130 may determine the second measured distance d2 in any suitable manner, which may depend on the position relation between the segment of the lane marker and the reference marker 154. For example, in the case where the segment of the lane marker is parallel to the reference marker 154, the computing device 130 may determine the distance between any point on the segment of the lane marker and the reference marker from the second measurement data. If the distance between the segment of the lane marker and the reference marker varies, the computing device 130 may determine the average value of the distance D between the lane marker 152 and the reference marker 154 in the area associated with the segment of the lane marker from the second measurement data. For example, the computing device 130 may also determine the second measured distance d2 by sampling the segment of the lane marker. Such examples are described further below.

At 1830, the computing device 130 may use the ratio d2/d1 of the second measured distance d2 to the first measured distance dl to correct the measurement data associated with the segment of the lane marker in the second measurement data D(T2). For example, the computing device 130 may use the ratio d2/d1 to correct the distance measurement value corresponding to any point on the segment of the lane marker in the second measurement data D(T2). By using the ratio of the measured distance of the segment of the lane marker to the reference marker 154, during the correction process of the second measurement data D(T2), the computing device 130 eliminates the influence of error factors such as hopping of individual data points of the measurement data. In addition, in some embodiments, for different sampled points, the computing device 130 may determine the above-mentioned segment of the lane marker near the sampled point. That is, for different sampled points, the above segment of the lane marker may be different, so that the locality of the sampled points is retained, that is, the factor used to correct the distance D is determined based on the distance between the segment of the lane marker nearby and the reference marker 154.

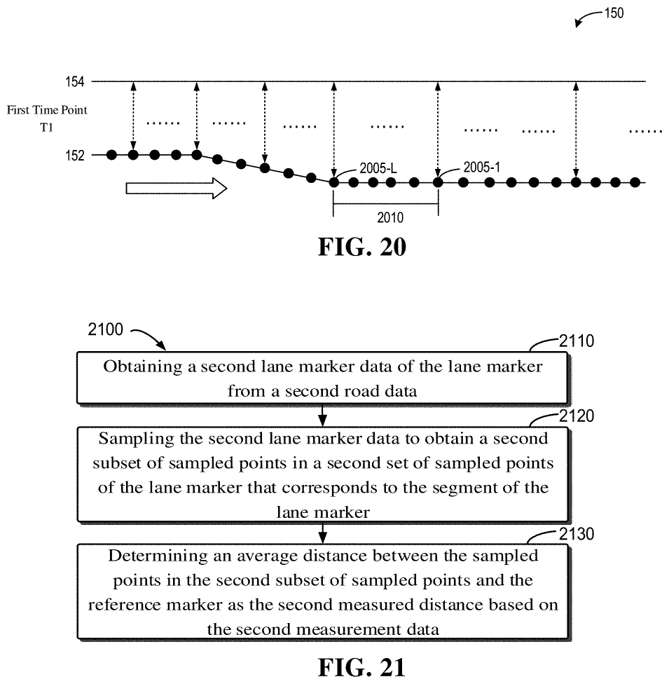

As mentioned above when describing the block 1810 of the example process 1800, the computing device 130 may also determine the first measured distance dl by sampling the segment of the lane marker. Specific examples of this manner are described below with reference to FIGS. 19 and 20.

FIG. 19 is a flowchart of an example process 1900 of determining a first measured distance dl from first road data 115 according to an embodiment of the present disclosure. In some embodiments, the example process 1900 may be implemented by the computing device 130 in the example environment 100, for example, may be implemented by a processor or processing unit of the computing device 130, or by various function modules of the computing device 130. In other embodiments, the example process 1900 may also be implemented by a computing device independent of the example environment 100, or may be implemented by other units or modules in the example environment 100.

FIG. 20 is a schematic diagram of determining a first measured distance dl from first road data 115 according to an embodiment of the present disclosure. It is understood that the specific shapes of the lane marker 152 and the reference marker 154 depicted in FIG. 20, and the number of sampled points and other elements are only schematic and are not intended to limit the scope of the present disclosure in any way. In other embodiments, the lane marker 152 and the reference marker 154 may have any shape, and may have any suitable number of sampling points. In addition, the numbering of the sampled points in FIG. 20 is only schematic, the sampled point numbered 1 is not necessarily the first sampled point, and the sampled point numbered L is not necessarily the last sampled point, the direction of numbered sampled points is not necessarily the same as the road direction for simplicity of description.

As illustrated in FIGS. 19 and 20, at 1910, the computing device 130 may obtain the first lane marker data of the lane marker 152 from the first road data 115. As described above, the first lane marker data refers to any data used to describe the lane marker 152 in the first road data 115. For example, in the case where the first road data 115 is a high-precision map, the computing device 130 may extract the set of coordinate points representing the lane marker 152 from the high-precision map data of the road 150, that is, the first lane marker data. In some embodiments, these coordinate points may be represented using latitude and longitude coordinates.

At 1920, the computing device 130 may sample the first lane marker data to obtain the first subset of sampled pointss 2005-1 to 2005-L (collectively referred to as subset of sampled points 2005) corresponding to the segment of the lane marker 2010 in the first set of sampled points of the lane marker 152. In some embodiments, sampling may be performed at a predetermined sampling interval, and the sampling interval may be determined by those skilled in the art according to factors such as specific accuracy requirements and technical environment. For example, in practice, the sampling interval may be set to 1 meter, which is beneficial to achieve a balance between the amount of calculation performed by the computing device 130 and the accuracy of calculation. However, it is understood that this specific value of the sampling interval is only exemplary and is not intended to limit the scope of the present disclosure in any way. In other embodiments, the sampling interval may be any suitable value. Generally, the computing device 130 may also sample the first lane marker data at an uneven sampling interval.

At 1930, the computing device 130 may determine an average distance between the sampled points 2005-1 to 2005-L and the reference marker 154 in the first subset of sampled points 2005 based on the first measurement data D(T1), as the first measured distance d1. In this way, the computing device 130 obtains the distance between a limited number of sampled points and the reference marker 154 by sampling to determine the above average distance. Therefore, the process of determining the above average distance may be simplified the computing device 130. In addition, by adjusting the sampling interval, the computing device 130 adjusts the accuracy of the above average distance.

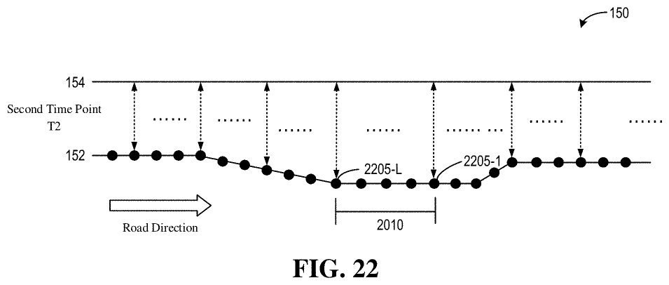

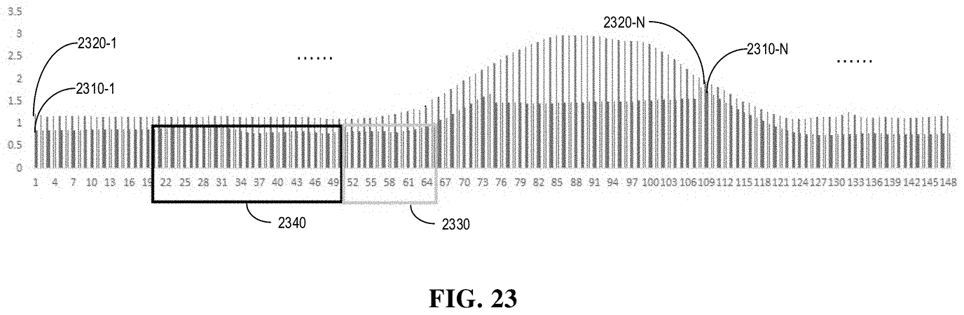

As mentioned above when describing the block 1820 of the example process 1800, the computing device 130 may also determine the second measured distance d2 by sampling. Specific examples of this way are described below with reference to FIGS. 21 and 22.

FIG. 21 is a flowchart of an example process 2100 of determining a second measured distance d2 from second road data 125 according to an embodiment of the present disclosure. In some embodiments, the example process 2100 may be implemented by the computing device 130 in the example environment 100, for example, may be implemented by a processor or processing unit of the computing device 130, or various function modules of the computing device 130. In other embodiments, the example process 2100 may also be implemented by a computing device independent of the example environment 100, or may be implemented by other units or modules in the example environment 100.

FIG. 22 is a schematic diagram of determining the second measured distance d2 from second road data 125 according to an embodiment of the present disclosure. It is understood that the specific shapes of the lane marker 152 and the reference marker 154 depicted in FIG. 22, and the number of sampled points and other elements are only schematic and are not intended to limit the scope of the present disclosure in any way. In other embodiments, the lane marker 152 and the reference marker 154 may have any shape, and may have any suitable number of sampled points. In addition, the numbering of the sampled points in FIG. 22 is only schematic, the sampled point numbered 1 is not necessarily the first sampled point, and the sampled point numbered L is not necessarily the last sampled point, the direction of numbered sampled points is not necessarily the same as the road direction for simplicity of description.

As illustrated in FIGS. 21 and 22, at 2110, the computing device 130 may obtain the second lane marker data of the lane marker 152 from the second road data 125. As described above, the second lane marker data refers to any data used to describe the lane marker 152 in the second road data 125. For example, in the case where the second road data 125 is a video taken by the low-precision device 120, the computing device 130 may extract the set of coordinate points representing the lane marker 152 from the video of the road 150, that is, the second lane marker data. In some embodiments, these coordinate points may be represented using latitude and longitude coordinates. It is understood that, depending on the specific form of the second road data 125, the computing device 130 may obtain the second lane marker data of the lane marker 152 in other proper ways.

At 2120, the computing device 130 may sample the second lane marker data to obtain the second subset of sampled points 2205-1 to 2205-L (collectively referred to as subset of sampled points 2205) corresponding to the segment of the lane marker 2010 in the second set of sampled points of the lane marker 152. In some embodiments, sampling may be performed at a predetermined sampling interval, and the sampling interval may be determined by those skilled in the art according to factors such as specific accuracy requirements and technical environment. For example, in practice, the sampling interval may be set to 1 meter, which is beneficial to achieve a balance between the amount of calculation performed by the computing device 130 and the accuracy of calculation. However, it is understood that this specific value of the sampling interval is only exemplary and is not intended to limit the scope of the present disclosure in any way. In other embodiments, the sampling interval may be any suitable value. Generally, the computing device 130 may also sample the first lane marker data at an uneven sampling interval.

At 2130, the computing device 130 may determine an average distance between the sampled points 2205-1 to 2205-L in the second subset of sampled points 2205 and the reference marker 154 based on the second measurement data D(T2) as the second measured distance d2. In this way, the computing device 130 obtains the distance between a limited number of sampled points and the reference marker 154 by sampling to determine the above average distance. Therefore, the process of determining the above average distance is simplified by the computing device 130. In addition, by adjusting the sampling interval, the computing device 130 can also adjust the accuracy of the above average distance.

### Reuse of Average Value for Correcting Average Value and Determining Changed Points

In the example process 1300 of determining changed points described above with reference to FIG. 13, for each sampled point of the first lane marker data, the computing device 130 determines t the first average distance between the first predetermined number of the sampled points before the sampled point and the reference marker, and the second average distance between the second predetermined number of the sampled points after the sampled point and the reference marker. In FIG. 14, the first predetermined number of sampled points corresponds to the segment of the lane marker 1410, and the second predetermined number of sampled points corresponds to the segment of the lane marker 1420. Similarly, in the example process 1600 of determining the changed point described with reference to FIG. 16, for each sampled point of the second lane marker data, the computing device 130 determines the third average distance between the first predetermined number of sampled points before the sampled point and the reference marker, and the fourth average distance between the second predetermined number of sampled points after the sampled point and the reference marker. In FIG. 17, the first predetermined number of sampled points corresponds to the segment of the lane marker 1710, and the second predetermined number of sampled points corresponds to the segment of the lane marker 1720.

On the other hand, as in the example process 1900 of determining the first measured distance d1 described above with reference to FIG. 19, the computing device 130 determines the average distance between the first subset of sampled points in the first set of sampled points and the reference marker 154, the first subset of sampled points corresponds to the lane segment 2010 in FIG. 20. Similarly, in the example process 2100 of determining the second measured distance d2 described with reference to FIG. 21, the computing device 130 determines an average distance between the second subset of sampled points in the second set of sampled points and the reference marker 154, the second subset of sampled points corresponds to the segment of the lane marker 2010 in FIG. 22.

Therefore, in some embodiments, the computing device 130 may use the average value obtained when determining the changed point for the correction process of the second measurement data D(T2). For example, for each sampled point of the first lane marker data, the computing device 130 may use the first average distance corresponding thereto in the example process 1300 as the first measured distance dl in the example process 1900, and for each sampled point in the second lane marker data, the third average distance corresponding thereto in the example process 1600 is taken as the second measured distance d2 in the example process 2100. That is, the segment of the lane marker 1410 in FIG. 14 may be used as the segment of the lane marker 2010 in FIG. 20, and the segment of the lane marker 1710 in FIG. 17 may be used as the segment of the lane marker 2010 in FIG. 22. Such an example is described below with reference to FIG. 23.

Alternatively, in other embodiments, for each sampled point of the first lane marker data, the computing device 130 may also use the second average distance corresponding thereto in the example process 1300 as the first measured distance dl in the example process 1900, and for each sampled point of the second lane marker data, the fourth average distance corresponding thereto in the example process 1600 is taken as the second measured distance d2 in the example process 2100. That is, the segment of the lane marker 1420 in FIG. 14 may be used as the segment of the lane marker 2010 in FIG. 20, and the segment of the lane marker 1720 in FIG. 17 may be used as the segment of the lane marker 2010 in FIG. 22.

FIG. 23 is a schematic diagram of processing the first measurement data 2310-1 to 2310-N (collectively referred to as first measurement data 2310) and the second measurement data 2320-1 to 2320-N (collectively referred to as first measurement data 2320) using backward stabilization window 2340 and forward smoothing window 2330 according to an embodiment of the present disclosure. In FIG. 23, the horizontal axis represents the number of sampled points on the lane marker 152, and the sampling interval is 1 meter. The vertical axis represents the measurement value of the distance D between the lane marker 152 and the reference marker 154. In addition, FIG. 23 further shows the first measurement data 2310 obtained based on the first road data 115 of the high-precision device 110 and the second measurement data 2320 obtained based on the second road data 125 of the low-precision device 120. It is noted that, for different sampled points, the backward stabilization window 2340 and the forward smoothing window 2330 slide while keeping the size constant.

As can be seen from FIG. 23, at each sampled point, the first measurement data 2310 and the second measurement data 2320 are different. In order to use the average value to correct the second measurement data 2320 described above as the average value for determining the changed point, the computing device 130 may set the length of the segment of the lane marker 2010 for the correction operation to be the same as the segment of the lane marker 1410 and 1710 for determining the changed point. In other words, the backward stabilization window 2340 shown in FIG. 23 may be used to determine the changed point, and the ratio of correcting the second measurement data 2320.

More specifically, whether a sampled point in the first measurement data is a changed point may be determined based on the difference between the average value of the sampling distance in the forward smoothing window 2330 and the average value of the sampling distance in the backward stabilization window 2340. Similarly, whether a sampled point in the second measurement data is a changed point can also be determined based on the difference between the average value of the sampling distance in the forward smoothing window 2330 and the average value of the sampling distance in the backward stabilization window 2340. Further, the ratio for correcting the second measurement data 2320 may be determined based on the average value of the sampling distance of the sampled points in the first measurement data in the backward stabilization window 2340 and the average value of the sampling distance of the sampled points in the second measurement data in the backward stabilization window 2340.

In some embodiments, the actual number of sampled points in the backward stabilization window 2340 may be set to 60 in combination with actual experimental results and requirements for computational efficiency. In the case of a sampling interval of 1 meter, it means that the backward stabilization window 2340 corresponds to a 60-meter segment of the lane marker. In addition, the number of sampled points in the forward smoothing window 2330 can be set to 20. In the case of a sampling interval of 1 meter, it means that the forward smoothing window 2330 corresponds to a segment of the lane marker of 20 meters. It is understood that the specific numerical values listed here are only exemplary and are not intended to limit the scope of the present disclosure in any way. In other embodiments, the computing device 130 may set the forward smoothing window 2330 and the backward stabilizing window 2340 to include any suitable number of sampled points, or correspond to any suitable length of segment of the lane marker.

For example, during the determination of the changed point from the second road data 125 obtained by the low-precision device 120, the computing device 130 may directly correct difference of average distances between a plurality of sampled points before and after a certain sampled point and the reference marker 154, which is also referred to as normalization, instead of correcting the second road data 125, for example, correcting the distance between each sampled point of the lane marker 152 and the reference point 154. In addition, since the above distance is assumed to be a “lane marker”, the above correction process for the difference value is also referred to as “lane marker width normalization”, and its specific calculation method is provided as follows.

First, for the second measurement data 2320 (also referred to as lane width, marked as left_lane_width) from the low-precision device 120, a sampled point is given, an average value (denoted as avgWidthGroupB) of the left_lane_width in the backward stabilization window 2340 (denoted as GroupB) is obtained. Then, the average value is normalized with the average value of left_lane_width (recorded as hpAvgWidthGroupB) in the backward stabilization window 2340 of the corresponding sampled point of the first measurement data 2310 from the high-precision device 110 (for example, linear normalization). The normalization ratio of the two is recorded as ratio_bk. That is, ratio_bk=avgWidthGroupB/hpAvgWidthGroupB.

Then, for the sampled point in the second measurement data 2320, the difference between the average value of the lane width in the forward smoothing window 2330 (denoted as GroupF) and the average value of the lane width in the backward stabilization window 2340 is calculated, which is expressed as lwcd=(avgWidthGroupF-avgWidthGroupB), i.e., the change value of left_lane_width. Next, the above ratio ratio_bk is used to correct (or normalize) the resulting difference, which is expressed as lwcd_corrected=lwcd*ratio_bk, i.e., the normalized lane width change value. Then, the computing device 130 may determine whether the sampled point of the second measurement data 2320 is a changed point according to whether the normalized lane width change value (i.e., lwcd_corrected) reaches a threshold (for example, 0.2 meters).

### Example Apparatus

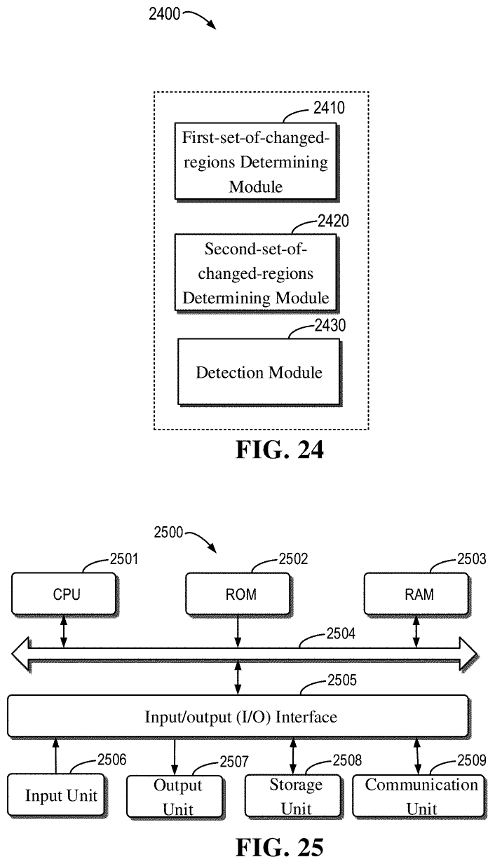

FIG. 24 is a schematic diagram of an apparatus 2400 for detecting a position change of a lane marker according to an embodiment of the present disclosure. In some embodiments, the apparatus 2400 may be included in the computing device 130 of FIG. 1 or implemented as the computing device 130.

As illustrated in FIG. 24, the apparatus includes: a first-set-of-changed-regions determining module 2410, a second-set-of-changed-regions determining module 2420, and a detection module 2430.

The first-set-of-changed-regions determining module 2410 is configured to determine, based on a first measurement data of a distance between the lane marker and a reference marker on a road, a first set of changed regions between the lane marker and the reference marker in which the distance has changed, wherein the first measurement data is obtained from a first road data which is obtained by collecting data of the road via a high-precision device at a first time point.

The second-set-of-changed-regions determining module 2420 is configured to, determine a second set of changed regions between the lane marker and the reference marker in which the distance has changed based on a second measurement data of the distance, wherein the second measurement data is obtained from a second road data which is obtained by collecting data of the road via a low-precision device at a second time point after the first time point.

The detection module 2430 is configured to detect the position change of the lane marker between the first time point and the second time point by comparing the first set of changed regions and the second set of changed regions.

In some embodiments, the first-set-of-changed-regions determining module 2410 includes: a first-lane-marker-data obtaining module, configured to obtain a first lane marker data of the lane marker from the first road data; a first-lane-marker-data sampling module configured to sample the first lane marker data to obtain a first set of sampled points of the lane marker; a first set-of-changed-points determining module, configured to determine a set of changed points from the first set of sampled points; and a first changed-region determining module, configured to, when it is determined that a length of a segment of the lane marker corresponding to a plurality of consecutive changed points in the set of changed points reaches a predetermined length, determine a region between the segment of the lane marker and the reference marker as a changed region in the first set of changed regions.

In some embodiments, for each sampled point in the first set of sampled points, the first-set-of-changed-regions determining module includes: a first-average-distance determining module, configured to determine a first average distance between a first predetermined number of sampled points before the sampled point and the reference marker based on the first measurement data; a second-average-distance determining module, configured to determine a second average distance between a second predetermined number of sampled points after the sampled point and the reference marker based on the first measurement data; and a first changed-point determining module, configured to determine the sampled point as the changed point when it is determined that a difference between the first average distance and the second average distance reaches a predetermined threshold.

In some embodiments, the apparatus 2400 further includes: a first-lane-marker-data and first-reference-marker-data obtaining module, configured to obtain a first lane marker data of the lane marker and a first reference marker data of the reference marker from the first road data; a first-lane-marker-data sampling module, configured to sample the first lane marker data to obtain a first set of sampled points of the lane marker; and a first-measurement-data determining module, configured to determine a distance between a sampled point in the first set of sampled points and the reference marker as the first measurement data, based on the first lane marker data and the first reference marker data.

In some embodiments, the apparatus 2400 further includes: a correction module, configured to correct the second measurement data by using the first measurement data.

In some embodiments, the correction module includes: a first-measured-distance determining module, configured to determine a first measured distance between a segment of the lane marker that is of a predetermined length and the reference marker based on the first measurement data; a second-measured-distance determining module, configured to determine a second measured distance between the segment of the lane marker and the reference marker based on the second measurement data; and a ratio-based correction module, configured to correct measurement data in the second measurement data that is associated with the segment of the lane marker, according to a ratio of the second measured distance to the first measured distance

In some embodiments, the first-measured-distance determining module includes: a first-lane-marker-data obtaining module, configured to obtain a first lane marker data of the lane marker from a first road data; a first-lane-marker-data sampling module, configured to sample the first lane marker data to obtain a first subset of sampled points in a first set of sampled points of the lane marker that corresponds to the segment of the lane marker; and a first-average-distance determining module, configured to determine an average distance between the sampled points in the first subset of sampled points and the reference marker as the first measured distance based on the first measurement data.

In some embodiments, the second-measured-distance determining module includes: a second-lane-marker-data obtaining module, configured to obtain a second lane marker data of the lane marker from a second road data; a second-lane-marker-data sampling module, configured to sample the second lane marker data to obtain a second subset of sampled points in a second set of sampled points of the lane marker that corresponds to the segment of the lane marker; and a second-average-distance determining module, configured to determine an average distance between the sampled points in the second subset of sampled points and the reference marker as the second measured distance based on the second measurement data.

In some embodiments, the second-set-of-changed-regions determining module 2420 includes: a second-lane-marker-data obtaining module, configured to obtain a second lane marker data of the lane marker from the second road data; a second-lane-marker-data sampling module, configured to sample the second lane marker data to obtain a second set of sampled points of the lane marker; a second set-of-changed-points determining module, configured to determine a set of changed points from the second set of sampled points; and a second changed-region determining module, configured to, when it is determined that a length of a segment of the lane marker corresponding to a plurality of consecutive changed points in the set of changed points reaches a predetermined length, determine a region between the segment of the lane marker and the reference marker as a changed region in the second set of changed regions.

In some embodiments, for each sampled point in the second set of sampled points, the second-set-of-changed-regions determining module includes: a third-average-distance determining module, configured to determine a third average distance between a first predetermined number of sampled points before the sampled point and the reference marker based on the second measurement data; a fourth-average-distance determining module, configured to determine a fourth average distance between a second predetermined number of sampled points after the sampled point and the reference marker based on the second measurement data; and a second changed point determining module, configured to determine the sampled point as the changed point when it is determined that a difference between the third average distance and the fourth average distance reaches a predetermined threshold.

In some embodiments, the apparatus 2400 further includes: a second-lane-marker-data and second-reference-marker-data obtaining module, configured to obtain a second lane marker data of the lane marker and a second reference marker data of the reference marker from the second road data; a second-lane-marker-data sampling module, configured to sample the second lane marker data to obtain a second set of sampled points of the lane marker; and a second-measurement-data determining module, configured to determine a distance between a sampled point in the second set of sampled points and the reference marker as the second measurement data, based on the second lane marker data and the second reference marker data.

In some embodiments, the second-lane-marker-data and second-reference-marker-data obtaining module includes: a video obtaining module, configured to obtain a video presenting the lane marker and the reference marker via the low-precision device; a sampled-point determining module, configured to determine a plurality of lane marker sampled points and a plurality of reference marker sampled points corresponding to a plurality of frames in the video, respectively; a second-lane-marker-data determining module, configured to determine the second lane marker data based on the plurality of the lane marker sampled points;

and a second-reference-marker-data determining module, configured to determine the second reference marker data based on the plurality of the reference marker sampled points.

In some embodiments, for each frame in the plurality of frames, the sampled-point determining module includes: a frame-position determining module, configured to determine a position corresponding to the frame based on a position trace of the low-precision device corresponding to the video; a parameter determining module, configured to determine lane marker parameters for representing the lane marker and reference marker parameters for representing the reference marker in the frame based on the position; and a sampled-point obtaining module, configured to obtain the lane marker sampled points of the lane marker and the reference marker sampled points of the reference marker at a predetermined distance in front of the low-precision device, based on the lane marker parameters and the reference marker parameters.

In some embodiments, the detection module 2430 includes: a changed-region difference determining module, configured to determine a changed region in the second set of changed regions that is different from the changed region in the first set of changed regions; and a position-change determining module, configured to determine whether the position change of the lane marker has occurred in said different changed region.

In some embodiments, the position-change determining module includes: an opening-in-central-reservation correspondence determining module, configured to determine whether said different changed region corresponds to an opening in a central reservation of the road based on the first road data when the reference marker is determined as a roadside marker; and a position-change determining module of an opening in a central reservation, configured to determine that the position change of the lane marker has occurred in said different changed region when it is determined that said different changed region does not correspond to the opening in the central reservation.

In some embodiments, the apparatus 2400 further includes at least one of: a first verifying module, configured to verify said different changed region by using multiple road data that are obtained by collecting data of the road multiple times via the low-precision device; and a second verifying module, configured to verify said different changed region by using further road data that is obtained by collecting data of the road via a further low-precision device other than the low-precision device.

In some embodiments, within each changed region in the first set of changed regions and the second set of changed regions, a variation in the distance between the lane marker and the reference marker reaches a threshold, and a length of the changed region reaches a predetermined length.

In some embodiments, the reference marker comprises a roadside marker or a further lane marker rather than the lane marker, the roadside marker representing a boundary of a portion in the road to be used for the vehicle.

In some embodiments, the high-precision device includes a device for collecting high-precision map data, and the low-precision device includes a drive recorder.

### Example Device

FIG. 25 is a schematic diagram of a device 2500 for implementing an embodiment of the present disclosure. As illustrated in FIG. 25, the device 2500 includes a central processing unit (CPU) 2501 that can be loaded into a computer in a random access storage device (RAM) 2503 according to computer program instructions stored in a read-only storage device (ROM) 2502 or loaded from a storage unit 2508 to perform various proper actions and processes. In the RAM 2503, various programs and data necessary for the operation of the device 2500 are stored. The CPU 2501, ROM 2502, and RAM 2503 are connected to each other through a bus 2504. An input/output (I/O) interface 2505 is also connected to a bus 2504.

Various components in the device 2500 are connected to the I/O interface 2505, which include: an input unit 2506, such as a keyboard, and a mouse; an output unit 2507, such as various types of displays, and speakers; a storage unit 2508, such as magnetic disks, and optical disks; and communication units 2509, such as network cards, modems, and wireless communication transceivers. The communication unit 2509 allows the device 2500 to exchange information/data with other devices through a computer network such as the Internet and/or various telecommunication networks.

The various processes and processes described above, for example, example processes 200, 500, 700, 900, 1000, 1200, 1300, 1500, 1600, 1800, 1900, and 2100, may be performed by the processing unit 2501. For example, in some embodiments, the example processes 200, 500, 700, 900, 1000, 1200, 1300, 1500, 1600, 1800, 1900, and 2100 may be implemented as computer software programs, which are tangibly included in machine-readable medium, for example, the storage unit 2508. In some embodiments, part or all of the computer program may be loaded and/or installed on the device 2500 via the ROM 2502 and/or the communication unit 2509. When a computer program is loaded into RAM 2503 and executed by CPU 2501, one or more steps of the example processes 200, 500, 700, 900, 1000, 1200, 1300, 1500, 1600, 1800, 1900, and 2100 described above can be performed.

### Other Instructions

As used herein, the term “include” and similar terms should be understood as an open inclusion, i.e. “includes but not limited to”. The term “based on” should be understood as “based at least in part on”. The term “an embodiment” or “this embodiment” should be understood as “at least one embodiment”. The terms “first”, and “second” may refer to different or the same objects. This article may also include other explicit and implicit definitions.

As used herein, the term “determine” encompasses a variety of actions. For example, “determine” may refer to operation, calculation, processing, exporting, surveying, searching (e.g., searching in a table, database, or another data structure), and identifying. In addition, “determine” may include receiving (e.g., receiving information), and accessing (e.g., accessing data in the memory). In addition, “determine” may include analysis, selection, choose, and establishment.

It is noted that the embodiments of the present disclosure may be implemented by hardware, software, or a combination of software and hardware. The hardware may be implemented with dedicated logic. The software may be stored in a memory and executed by an appropriate instruction execution system, such as a microprocessor or specially designed hardware. Those skilled in the art may understand that the above-mentioned devices and methods may be implemented using computer-executable instructions and/or be contained in processor control codes, for example, codes provided on a programmable memory or a data carrier such as an optical or electronic signal carrier.

In addition, although the operations of the method of the present disclosure are described in a specific order in the drawings, this does not require or imply that the operations must be performed in the specific order, or all the operations shown must be performed to achieve the desired result. Conversely, the order of execution of the steps depicted in the flowchart can be change. Additionally or alternatively, some steps may be omitted, steps may be combined into one step for execution, and/or one step may be decomposed into multiple steps for execution. It is noted that the features and functions of two or more devices according to the present disclosure may be embodied in one device. Conversely, the features and functions of one device described above is further divided into multiple devices to be embodied.

Although the present disclosure has been described with reference to several specific embodiments, it is understood that the present disclosure is not limited to the disclosed specific embodiments. This disclosure is intended to cover various modifications and equivalent arrangements included within the spirit and scope of the appended claims.

What is claimed is:

1. A method for detecting a position change of a lane marker, comprising:
determining, based on a first measurement data of a distance between the lane marker and a reference marker on a road, a first set of changed regions between the lane marker and the reference marker in which the distance has changed, wherein the first measurement data is obtained from a first road data which is obtained by collecting data of the road via a high-precision device at a first time point;
determining a second set of changed regions between the lane marker and the reference marker in which the distance has changed based on a second measurement data of the distance, wherein the second measurement data is obtained from a second road data which is obtained by collecting data of the road via a low-precision device at a second time point after the first time point; and
detecting the position change of the lane marker between the first time point and the second time point by comparing the first set of changed regions and the second set of changed regions.

2. The method according to claim 1, wherein determining the first set of changed regions comprises:
obtaining a first lane marker data of the lane marker from the first road data;
sampling the first lane marker data to obtain a first set of sampled points of the lane marker;
determining a set of changed points from the first set of sampled points; and
in response to a determination that a length of a segment of the lane marker corresponding to a plurality of consecutive changed points in the set of changed points reaches a predetermined length, determining a region between the segment of the lane marker and the reference marker as a changed region in the first set of changed regions.

3. The method according to claim 2, wherein determining the set of changed points comprises:
for each sampled point in the first set of sampled points,
determining a first average distance between a first predetermined number of sampled points before the sampled point and the reference marker based on the first measurement data;
determining a second average distance between a second predetermined number of sampled points after the sampled point and the reference marker based on the first measurement data; and
determining the sampled point as the changed point in response to a determination that a difference between the first average distance and the second average distance reaches a predetermined threshold.

4. The method according to claim 1, further comprising:
obtaining a first lane marker data of the lane marker and a first reference marker data of the reference marker from the first road data;
sampling the first lane marker data to obtain a first set of sampled points of the lane marker; and
determining a distance between a sampled point in the first set of sampled points and the reference marker as the first measurement data, based on the first lane marker data and the first reference marker data.

5. The method according to claim 1, further comprising:
correcting the second measurement data by using the first measurement data.

6. The method according to claim 5, wherein correcting the second measurement data comprises:
determining a first measured distance between a segment of the lane marker that is of a predetermined length and the reference marker based on the first measurement data;
determining a second measured distance between the segment of the lane marker and the reference marker based on the second measurement data; and
correcting measurement data in the second measurement data that is associated with the segment of the lane marker, according to a ratio of the second measured distance to the first measured distance.

7. The method according to claim 6, wherein determining the first measured distance comprises:
obtaining a first lane marker data of the lane marker from a first road data;
sampling the first lane marker data to obtain a first subset of sampled points in a first set of sampled points of the lane marker that corresponds to the segment of the lane marker; and
determining an average distance between the sampled points in the first subset of sampled points and the reference marker as the first measured distance based on the first measurement data.

8. The method according to claim 6, wherein determining the second measured distance comprises:
obtaining a second lane marker data of the lane marker from a second road data;
sampling the second lane marker data to obtain a second subset of sampled points in a second set of sampled points of the lane marker that corresponds to the segment of the lane marker; and
determining an average distance between the sampled points in the second subset of sampled points and the reference marker as the second measured distance based on the second measurement data.

9. The method according to claim 1, wherein determining the second set of changed regions comprises:
obtaining a second lane marker data of the lane marker from the second road data;
sampling the second lane marker data to obtain a second set of sampled points of the lane marker;
determining a set of changed points from the second set of sampled points; and
in response to a determination that a length of a segment of the lane marker corresponding to a plurality of consecutive changed points in the set of changed points reaches a predetermined length, determining a region between the segment of the lane marker and the reference marker as a changed region in the second set of changed regions.

10. The method according to claim 9, wherein determining the set of changed points comprises:
for each sampled point in the second set of sampled points,
determining a third average distance between a first predetermined number of sampled points before the sampled point and the reference marker based on the second measurement data;
determining a fourth average distance between a second predetermined number of sampled points after the sampled point and the reference marker based on the second measurement data; and
determining the sampled point as the changed point in response to a determination that a difference between the third average distance and the fourth average distance reaches a predetermined threshold.

11. The method according to claim 1, further comprising:
obtaining a second lane marker data of the lane marker and a second reference marker data of the reference marker from the second road data;
sampling the second lane marker data to obtain a second set of sampled points of the lane marker; and
determining a distance between a sampled point in the second set of sampled points and the reference marker as the second measurement data, based on the second lane marker data and the second reference marker data.

12. The method according to claim 11, wherein obtaining the second lane marker data and the second reference marker data, comprises:
obtaining a video presenting the lane marker and the reference marker via the low-precision device;
determining a plurality of lane marker sampled points and a plurality of reference marker sampled points corresponding to a plurality of frames in the video, respectively;
determining the second lane marker data based on the plurality of the lane marker sampled points; and
determining the second reference marker data based on the plurality of the reference marker sampled points.

13. The method according to claim 12, wherein determining the plurality of the lane marker sampled points and the plurality of the reference marker sampled points, comprises:
for each frame in the plurality of frames,
determining a position corresponding to the frame based on a position trace of the low-precision device corresponding to the video;
determining lane marker parameters for representing the lane marker and reference marker parameters for representing the reference marker in the frame based on the position; and
obtaining the lane marker sampled points of the lane marker and the reference marker sampled points of the reference marker at a predetermined distance in front of the low-precision device, based on the lane marker parameters and the reference marker parameters.

14. The method according to claim 1, wherein detecting the position change of the lane marker comprises:
determining a changed region in the second set of changed regions that is different from the changed region in the first set of changed regions; and
determining whether the position change of the lane marker has occurred in said different changed region.

15. The method according to claim 14, wherein determining whether the position change of the lane marker has occurred comprises:
determining whether said different changed region corresponds to an opening in a central reservation of the road based on the first road data in a case where the reference marker is determined as a roadside marker; and
determining that the position change of the lane marker has occurred in said different changed region in response to a determination that said different changed region does not correspond to the opening in the central reservation.

16. The method according to claim 14, further comprising at least one of:
verifying said different changed region by using multiple road data that are obtained by collecting data of the road multiple times via the low-precision device; and
verifying said different changed region by using further road data that is obtained by collecting data of the road via a further low-precision device other than the low-precision device.

17. The method according to claim 1, wherein, within each changed region in the first set of changed regions and the second set of changed regions, a variation in the distance between the lane marker and the reference marker reaches a threshold, and a length of the changed region reaches a predetermined length.

18. The method according to claim 1, wherein the reference marker comprises a roadside marker or a further lane marker rather than the lane marker, the roadside marker representing a boundary of a portion in the road to be used for the vehicle, and
wherein the high-precision device comprises a device for collecting high-precision map data, and the low-precision device comprises a drive recorder.

19. An apparatus for detecting a position change of a lane marker, comprising:
one or more processors; and
a storage device, configured to store one or more programs,
wherein when the one or more programs are executed by the one or more processors, the one or more processors are caused to implement a method for detecting a position change of a lane marker, comprising:
determining, based on a first measurement data of a distance between the lane marker and a reference marker on a road, a first set of changed regions between the lane marker and the reference marker in which the distance has changed, wherein the first measurement data is obtained from a first road data which is obtained by collecting data of the road via a high-precision device at a first time point;
determining a second set of changed regions between the lane marker and the reference marker in which the distance has changed based on a second measurement data of the distance, wherein the second measurement data is obtained from a second road data which is obtained by collecting data of the road via a low-precision device at a second time point after the first time point; and
detecting the position change of the lane marker between the first time point and the second time point by comparing the first set of changed regions and the second set of changed regions.

20. A tangible, non-transitory computer readable storage medium having a computer program stored thereon, wherein, when the program is executed by a processor, the program implements a method for detecting a position change of a lane marker, comprising:
determining, based on a first measurement data of a distance between the lane marker and a reference marker on a road, a first set of changed regions between the lane marker and the reference marker in which the distance has changed, wherein the first measurement data is obtained from a first road data which is obtained by collecting data of the road via a high-precision device at a first time point;
determining a second set of changed regions between the lane marker and the reference marker in which the distance has changed based on a second measurement data of the distance, wherein the second measurement data is obtained from a second road data which is obtained by collecting data of the road via a low-precision device at a second time point after the first time point; and
detecting the position change of the lane marker between the first time point and the second time point by comparing the first set of changed regions and the second set of changed regions.
